(19) United States
(12) Patent Application Publication
(10) Pub. No.: US 2013/0050527 A1
(43) Pub. Date: Feb. 28, 2013

(54) IMAGE CREATION METHOD, IMAGE CREATION APPARATUS AND RECORDING MEDIUM

(71) Applicant: Mitsuyasu NAKAJIMA, Tokyo (JP)

(72) Inventor: Mitsuyasu NAKAJIMA, Tokyo (JP)

(73) Assignee: CASIO COMPUTER CO., LTD., Tokyo (JP)

(21) Appl. No.: 13/588,464

(22) Filed: Aug. 17, 2012

(30) Foreign Application Priority Data
Aug. 25, 2011 (JP) 2011-183546

(51) Int. Cl. H04N 5/76

(52) U.S. Cl. 348/231.99; 348/E05.031

(57) ABSTRACT

An image creation method includes: obtaining a two-dimensional still image; first setting motion control points related to motion control for a subject in a subject region of the obtained still image, the subject region including the subject; second setting overlap control points related to overlap control for constituent regions composing the subject region, at respective positions corresponding to the overlap reference points; calculating a position in the depth direction of each constituent region for each predetermined time interval based on the reference position of the overlap reference point corresponding to each overlap control point; and creating a deformed image by deforming the subject region according to motions of the motion control points, and the creating includes displacing the respective constituent regions in the subject region in the depth direction at positions different from one another for each predetermined time interval based on the position calculated by the calculating.

### CROSS-REFERENCE TO RELATED APPLICATIONS

This application is based upon and claims the benefit of priority from the prior Japanese Patent Application No. 2011-183546, filed on Aug. 25, 2011, the entire contents of which are incorporated herein by reference.

### BACKGROUND OF THE INVENTION

1. Field of the Invention

The present invention relates to an image creation method, an image creation apparatus and a recording medium.

2. Description of Related Art

Heretofore, there has been known a technology for moving a two-dimensional still image by setting motion control points at desired positions of the still image concerned, and by designating desired motions to the motion control points to which motions are desired to be imparted (U.S. Pat. No. 8,063,917).

However, in the case of the foregoing technology, the motions of the motion control points are expressed in a two-dimensional space. Accordingly, there is a problem that expression of a depth cannot be made as appropriate for such a motion of overlapping a part of a region of the still image concerned on other region thereof fore and aft.

### SUMMARY OF THE INVENTION

The present invention has been made in consideration of the problem as described above. It is an object of the present invention to provide an image creation method, an image creation apparatus and a recording medium, which are capable of appropriately performing the expression of the depth in a deformed image obtained by deforming the two-dimensional still image.

According to an aspect of the present invention, there is provided an image creation method that uses an image creation apparatus including a storage unit that stores positional information indicating positions of a plurality of overlap reference points in a two-dimensional space, the positions being set for each of a plurality of regions composing a model region including a moving subject model of a reference image, and being associated with a reference position in a depth direction with respect to the two-dimensional space for each predetermined time interval, the image creation method including:

obtaining a two-dimensional still image;

first setting a plurality of motion control points related to motion control for a subject in a subject region of the still image obtained by the obtaining, the subject region including the subject;

second setting a plurality of overlap control points related to overlap control for a plurality of constituent regions, the constituent regions composing the subject region, at respective positions corresponding to the plurality of overlap reference points in the subject region of the still image obtained by the obtaining;

calculating a position in the depth direction of each of the plurality of constituent regions for each predetermined time interval based on the reference position in the depth direction of the overlap reference point corresponding to each of the plurality of overlap control points; and

creating a deformed image obtained by deforming the subject region in accordance with motions of the plurality of motion control points,

and the creating includes displacing the respective constituent regions in the subject region in the depth direction at positions different from one another in the depth direction for each predetermined time interval based on the position in the depth direction for each predetermined time interval, the position being calculated by the calculating.

According to another aspect of the present invention, there is provided an image creation apparatus including a storage unit that stores positional information indicating positions of a plurality of overlap reference points in a two-dimensional space, the positions being set for each of a plurality of regions composing a model region including a moving subject model of a reference image, and being associated with a reference position in a depth direction with respect to the two-dimensional space for each predetermined time interval, the image creation apparauts including:

an obtaining unit which obtains a two-dimensional still image;

a first setting unit which sets a plurality of motion control points related to motion control for a subject in a subject region of the still image obtained by the obtaining unit, the subject region including the subject;

a second setting unit which sets a plurality of overlap control points related to overlap control for a plurality of constituent regions, the constituent regions composing the subject region, at respective positions corresponding to the plurality of overlap reference points in the subject region of the still image obtained by the obtaining unit;

a calculating unit which calculates a position in the depth direction of each of the plurality of constituent regions for each predetermined time interval based on the reference position in the depth direction of the overlap reference point corresponding to each of the plurality of overlap control points; and

a creating unit which creates a deformed image obtained by deforming the subject region in accordance with motions of the plurality of motion control points,

and the creating unit performs processing of displacing the respective constituent regions in the subject region in the depth direction at positions different from one another in the depth direction for each predetermined time interval based on the position in the depth direction for each predetermined time interval in the plurality of constituent regions, the position being calculated by the calculating unit.

According to still another aspect of the present invention, there is provided a recording medium recording a program which makes a computer of an image creation apparatus including a storage unit that stores positional information indicating positions of a plurality of overlap reference points in a two-dimensional space, the positions being set for each of a plurality of regions composing a model region including a moving subject model of a reference image, and being associated with a reference position in a depth direction with respect to the two-dimensional space for each predetermined time interval, function as:

an obtaining function which obtains a two-dimensional still image;

a first setting function which sets a plurality of motion control points related to motion control for a subject in a subject region of the still image obtained by the obtaining function, the subject region including the subject;

a second setting function which sets a plurality of overlap control points related to overlap control for a plurality of constituent regions, the constituent regions composing the subject region, at respective positions corresponding to the plurality of overlap reference points in the subject region of the still image obtained by the obtaining function;

a calculating function which calculates a position in the depth direction of each of the plurality of constituent regions for each predetermined time interval based on the reference position in the depth direction of the overlap reference point corresponding to each of the plurality of overlap control points; and

a creating function which creates a deformed image obtained by deforming the subject region in accordance with motions of the plurality of motion control points,

and the creating function includes a function of displacing the respective constituent regions in the subject region in the depth direction at positions different from one another in the depth direction for each predetermined time interval based on the position in the depth direction for each predetermined time interval in the plurality of constituent regions, the position being calculated by the calculating function.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram showing a schematic configuration of an animation creation system of an embodiment to which the present invention is applied;

FIG. 2 is a block diagram showing a schematic configuration of a user terminal that composes the animation creation system of FIG. 1;

FIG. 3 is a block diagram showing a schematic configuration of a server that composes the animation creation system of FIG. 1;

FIG. 4 is a view schematically showing motion information stored in the server of FIG. 3;

FIG. 5 is a flowchart showing an example of operations related to animation creation processing by the animation creation system of FIG. 1;

FIG. 6 is a flowchart showing a follow-up of the animation creation processing of FIG. 5;

FIG. 7 is a flowchart showing an example of operations related to frame image creation processing in the animation creation processing of FIG. 5;

FIG. 8 is a flowchart showing an example of operations related to configuration region specification processing in the animation creation processing of FIG. 5;

FIG. 9 is a flowchart showing an example of operations related to frame drawing processing in the animation creation processing of FIG. 5;

FIG. 10 is a view schematically showing layer information stored in the server of FIG. 3;

FIG. 11A is a view schematically showing an example of an image related to the frame image creation processing of FIG. 7;

FIG. 11B is a view schematically showing an example of the image related to the frame image creation processing of FIG. 7;

FIG. 12A is a view schematically showing an example of the image related to the frame image creation processing of FIG. 7;

FIG. 12B is a view schematically showing an example of the image related to the frame image creation processing of FIG. 7;

FIG. 12C is a view schematically showing an example of the image related to the frame image creation processing of FIG. 7;

FIG. 13A is a view schematically showing an example of the image related to the frame image creation processing of FIG. 7; and

FIG. 13B is a view schematically showing an example of the image related to the frame image creation processing of FIG. 7.

### DETAILED DESCRIPTION OF THE PREFERRED EMBODIMENT

A description is made below of a specific mode of the present invention by using the drawings. Note that the scope of the invention is not limited to the illustrated example.

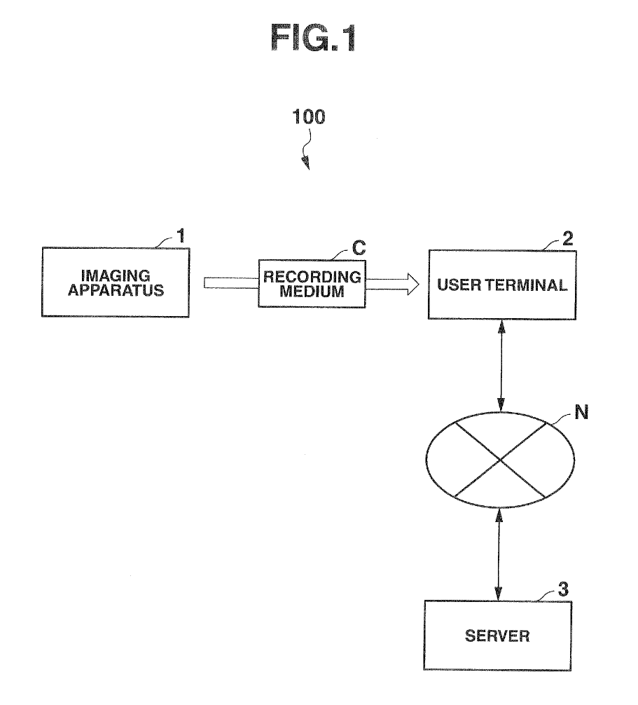

FIG. 1 is a block diagram showing a schematic configuration of an animation creation system 100 of an embodiment to which the present invention is applied.

As shown in FIG. 1, the animation creation system 100 of this embodiment includes: an imaging apparatus 1; a user terminal 2; and a server 3, in which the user terminal 2 and the server 3 are connected to each other through a predetermined communication network N so as to be capable of transferring a variety of information therebetween.

First, a description is made of the imaging apparatus 1.

The imaging apparatus 1 is provided with an imaging function to image a subject, a recording function to record image data of an imaged image in a recording medium C, and the like. That is to say, a device known in public is applicable as the imaging apparatus 1, and for example, the imaging apparatus 1 includes not only a digital camera that has the imaging function as a main function, but also a portable terminal such as a cellular phone provided with the imaging function though the imaging function is not regarded as a main function therein.

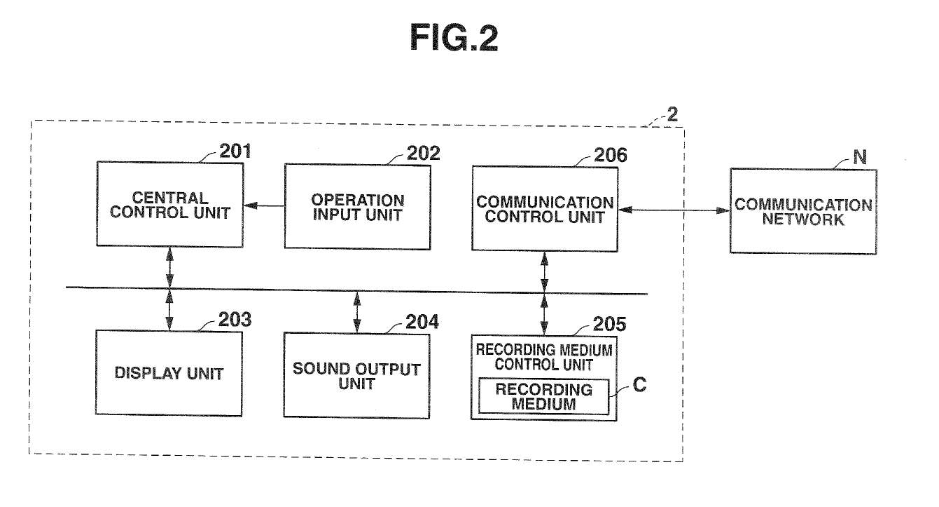

Next, a description is made of the user terminal 2 with reference to FIG. 2.

For example, the user terminal 2 is composed of a personal computer or the like, accesses a Web page (for example, an animation creating page) established by the server 3, and inputs a variety of instructions on the Web page.

FIG. 2 is a block diagram showing a schematic configuration of the user terminal 2.

As shown in FIG. 2, specifically, the user terminal 2 includes: a central control unit 201; an operation input unit 202; a display unit 203; a sound output unit 204; a recording medium control unit 205; a communication control unit 206; and the like.

The central control unit 201 controls the respective units of the user terminal 2. Specifically, the central control unit 201 includes a CPU, a RAM, and a ROM (which are not shown), and performs a variety of control operations in accordance with a variety of processing programs (not shown) for the user terminal 2, which are stored in the ROM. In this event, the CPU allows a storage region in the RAM to store results of a variety of processing, and allows the display unit 203 to display such processing results according to needs.

For example, the RAM includes: a program storage region for expanding a processing program to be executed by the CPU, and the like; a data storage region for storing input data, processing results generated in the event where the processing program is executed, and the like; and the like.

The ROM stores: programs stored in a mode of a computer-readable program code, specifically, a system program executable by the user terminal 2, a variety of processing programs executable by the system program concerned; data for use in the event of executing these various processing programs; and the like.

For example, the operation input unit 202 includes: a keyboard composed of data input keys for inputting numeric values, letters and the like; cursor keys for performing selection and feeding operations of data, and the like; a variety of function keys; and the like. The operation input unit 202 outputs a depression signal of a key depressed by a user and an operation signal of the mouse to the CPU of the central control unit 201.

Note that such a configuration may also be adopted, which arranges a touch panel (not shown) as the operation input unit 202 on a display screen of the display unit 203, and inputs a variety of instructions in response to contact positions of the touch panel.

For example, the display unit 203 is composed of a display such as an LCD and a cathode ray tube (CRT), and displays a variety of information on the display screen under control of the CPU of the central control unit 201.

That is to say, for example, based on page data of the Web page (for example, the animation creating page) transmitted from the server 3 and received by the communication control unit 206, the display unit 203 displays a Web page, which corresponds thereto, on the display screen. Specifically, based on image data of a variety of processing screens related to animation creation processing (described later), the display unit 203 displays a variety of processing screens on the display screen.

For example, the sound output unit 204 is composed of a D/A converter, a low pass filter (LPF), an amplifier, a speaker and the like, and emits a sound under the control of the CPU of the central control unit 201.

That is to say, for example, based on music information transmitted from the server 3 and received by the communication control unit 206, the sound output unit 204 converts digital data of the music information into analog data by the D/A converter, and emits such a music at predetermined tone, pitch and duration from the speaker through the amplifier. Moreover, the sound output unit 204 may emit a sound of one sound source (for example, a musical instrument), or may emit sounds of a plurality of sound sources simultaneously.

The recording medium control unit 205 is composed so that the recording medium C can be freely attachable/detachable thereto/therefrom, and controls readout of data from the recording medium C attached thereonto and controls write of data to the recording medium C. That is to say, the recording medium control unit 205 reads out image data (YUV data) of a subject existing image (not shown), which is related to the animation creation processing (described later), from the recording medium C detached from the imaging apparatus 1 and attached onto the recording medium control unit 205, and then outputs the image data to the communication control unit 206.

Here, the subject existing image refers to an image in which a main subject exists on a predetermined background. Moreover, in the recording medium C, there is recorded image data of the subject existing image, which is encoded by an image processing unit (not shown) of the imaging apparatus 1 in accordance with a predetermined encoding format (for example, a JPEG format and the like).

Then, the communication control unit 206 transmits the image data of the subject existing image, which is inputted thereto, to the server 3 through the predetermined communication network N.

For example, the communication control unit 206 is composed of a modulator/demodulator (MODEM), a terminal adapter, and the like. The communication control unit 206 is a unit for performing communication control for information with an external instrument such as the server 3 through the predetermined communication network N.

Note that, for example, the communication network N is a communication network constructed by using a dedicated line or an existing general public line, and it is possible to apply a variety of line forms such as a local area network (LAN) and a wide area network (WAN). Moreover, for example, the communication network N includes: a variety of communication networks such as a telephone network, an ISDN network, a dedicated line, a mobile network, a communication satellite line, and a CATV network; an internet service provider that connects these to one another; and the like.

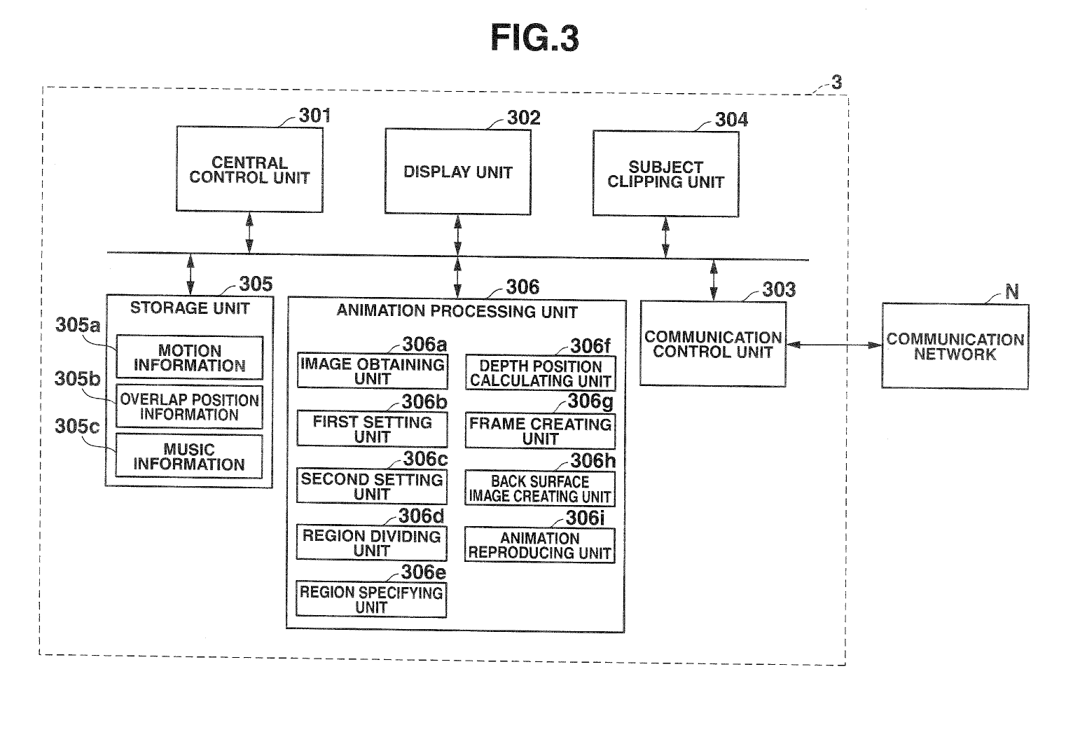

Next, a description is made of the server 3 with reference to FIG. 3.

The server 3 is a Web (World Wide Web) server that is provided with a function to establish the Web page (for example, the animation creating page) on the Internet. The server 3 transmits the page data of the Web page to the user terminal 2 in response to an access from the user terminal 2 concerned. Moreover, as an image creation apparatus, the server 3 sets a plurality of overlap control points T, which are related to overlap control for a plurality of constituent regions L . . . , at the respective positions corresponding to a plurality of overlap reference points R . . . associated with a reference position in a depth direction with respect to a two-dimensional space in a subject region B of a still image. Then, based on a position in the depth direction of each of the plurality of constituent regions L for each predetermined time interval, the position being calculated in accordance with the reference position in the depth direction of each of the overlap reference points R, which corresponds to each of the plurality of overlap control points T, the server 3 displaces the respective constituent regions L in the subject region B in the depth direction at positions different from one another in the depth direction concerned for each predetermined time interval, and in addition, creates a deformed image obtained by deforming the subject region B in accordance with motions of a plurality of motion control points S set in the subject region B.

FIG. 3 is a block diagram showing a schematic configuration of the server 3.

As shown in FIG. 3, specifically, the server 3 is composed by including: a central control unit 301; a display unit 302; a communication control unit 303; a subject clipping unit 304; a storage unit 305; an animation processing unit 306; and the like.

The central control unit 301 controls the respective units of the server 3. Specifically, the central control unit 301 includes a CPU, a RAM, and a ROM (which are not shown), and performs a variety of control operations in accordance with a variety of processing programs (not shown) for the server 3, which are stored in the ROM. In this event, the CPU allows a storage region in the RAM to store results of a variety of processing, and allows the display unit 302 to display such processing results according to needs.

For example, the RAM includes: a program storage region for expanding a processing program to be executed by the CPU, and the like; a data storage region for storing input data, processing results generated in the event where the processing program is executed, and the like; and the like.

The ROM stores: programs stored in a mode of a computer-readable program code, specifically, a system program executable by the server 3, a variety of processing programs executable by the system program concerned; data for use in the event of executing these various processing programs; and the like.

For example, the display unit 302 is composed of a display such as an LCD and a cathode ray tube (CRT), and displays a variety of information on a display screen under control of the CPU of the central control unit 301.

For example, the communication control unit 303 is composed of a MODEM, a terminal adapter, and the like. The communication control unit 303 is a unit for performing communication control for information with an external instrument such as the user terminal 3 through the predetermined communication network N.

Specifically, for example, the communication control unit 303 receives the image data of the subject existing image, which is transmitted from the user terminal 2 through the predetermined communication network N in the animation creation processing (described later), and outputs the image data concerned to the CPU of the central control unit 301.

The CPU of the central control unit 301 outputs the image data of the subject existing image, which is inputted thereto, to the subject clipping unit 304.

The subject clipping unit 304 creates a subject clipped image (not shown) from the subject existing image.

That is to say, by using a subject clipping method known in public, the subject clipping unit 304 creates a subject clipped image in which the subject region including the subject is clipped from the subject existing image. Specifically, the subject clipping unit 304 obtains the image data of the subject existing image outputted from the CPU of the central control unit 301, and partitions the subject existing image, which is displayed on the display unit 203, by boundary lines (not shown) drawn on the subject existing image concerned, for example, based on a predetermined operation for the operation input unit 202 (for example, the mouse and the like) of the user terminal 2 by the user. Subsequently, the subject clipping unit 304 estimates a background of the subject in a plurality of partition regions obtained by the partitioning by such clipping lines of the subject existing image, performs a predetermined arithmetic operation based on pixel values of the respective pixels of the background, and estimates that a background color of the subject is a predetermined single color. Thereafter, between such a background image with the predetermined single color and the subject existing image, the subject clipping unit 304 creates difference information (for example, a difference degree map and the like) of the respective pixels corresponding thereto. Then, the subject clipping unit 304 compares pixel values of the respective pixels in the created difference information with a predetermined threshold value, then binarizes the pixel values, and thereafter, performs labeling processing for assigning the same numbers to pixel aggregates which compose the same connected components, and defines a pixel aggregate with a maximum area as a subject portion.

Thereafter, for example, the subject clipping unit 304 implements a low pass filter for the binarized difference information, in which the foregoing pixel aggregate with the maximum area is “1”, and other portions are “0”, generates an intermediate value on a boundary portion, and thereby creates an alpha value. Then, the subject clipping unit 304 creates an alpha map (not shown) as positional information indicating a position of the subject region in the subject clipped image.

For example, the alpha value (0≦α≦1) is a value that represents weight in the event of performing alpha blending for the image of the subject region with the predetermined background for each pixel of the subject existing image. In this case, an alpha value of the subject region becomes “1”, and a transmittance of the subject existing image with respect to the predetermined background becomes 0%. Meanwhile, an alpha value of such a background portion of the subject becomes “0”, and a transmittance of the subject existing image with respect to the predetermined background becomes 100%.

Then, based on the alpha map, the subject clipping unit 304 synthesizes the subject image with the predetermined single color image and creates image data of the subject clipped image so that, among the respective pixels of the subject existing image, the pixels with the alpha value of “1” cannot be transmitted through the predetermined single color image, and the pixels with the alpha value of “0” can be transmitted therethrough.

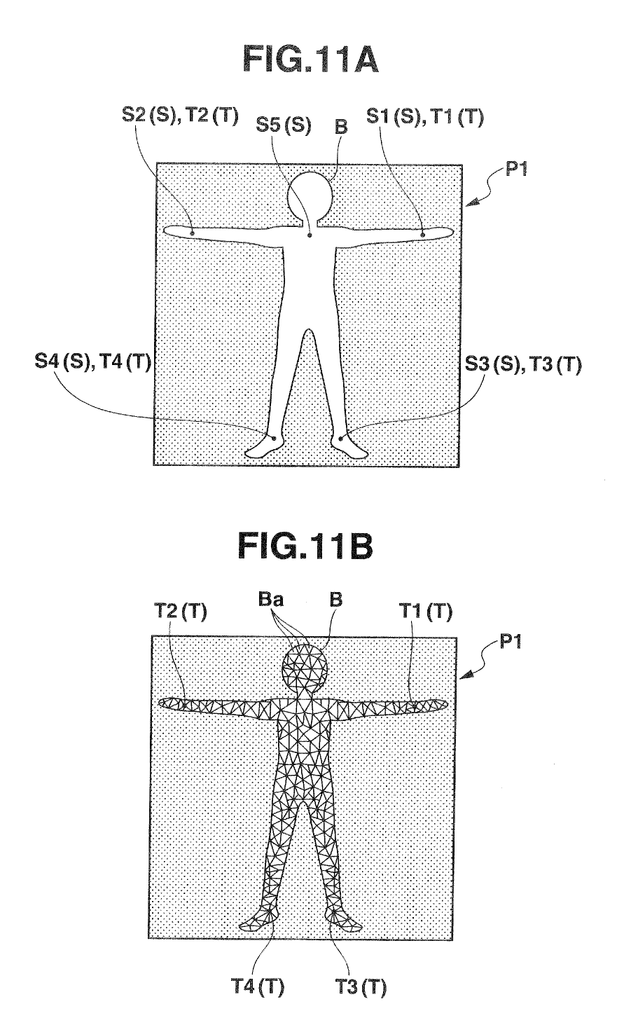

Moreover, based on the alpha map, the subject clipping unit 304 creates a mask image P1 (refer to FIG. 11A) as a binary image, in which a pixel value of the respective pixels of the subject region B (region shown white in FIG. 11A) is set at a first pixel value (for example, “1” and the like), and a pixel value of the respective pixels of such a background region (region dotted in FIG. 11A) is set at a second pixel value (for example, “0” and the like) different from the first pixel value. That is to say, the subject clipping unit 304 creates the mask image P1 as the positional information indicating the position of the subject region B in the subject clipped image.

For example, the image data of the subject clipped image is data associated with the positional information of the created alpha map, mask image P1, and the like.

Note that the above-described clipping method by the subject clipping unit 304 is merely an example, a subject clipping method of the present invention is not limited to this, and any method may be applied as long as the method concerned is a publicly known method of clipping the subject region, which includes the subject, from the subject existing image.

Moreover, for example, as the image data of the subject clipped image, image data of an RGBA format may be applied, and specifically, information of the transmittance A is added to the respective colors defined in an RGB color space. In this case, by using the information of the transmittance A, the subject clipping unit 304 may create the positional information (not shown) indicating the position of the subject region B in the subject clipped image.

For example, the storage unit 305 is composed of a nonvolatile semiconductor memory, a hard disc drive (HDD) or the like, and stores the page data of the Web page, which is to be transmitted to the user terminal 2, the image data of the subject clipped image, which is created by the subject clipping unit 304, and the like.

Moreover, the storage unit 305 stores plural pieces of motion information 305a for use in the animation creation processing.

Each piece of the motion information 305a is information indicating motions of a plurality of motion reference points Q . . . in a two-dimensional flat space defined by two axes (for example, an x-axis, a y-axis and the like) perpendicular to each other, and in a three-dimensional stereoscopic space defined by an axis (for example, a z-axis or the like) perpendicular to these two axes in addition thereto. Note that each piece of the motion information 305a may also be such information that imparts a depth to the motions of the plurality of motion reference points Q . . . by rotating the two-dimensional flat space about a predetermined rotation axis.

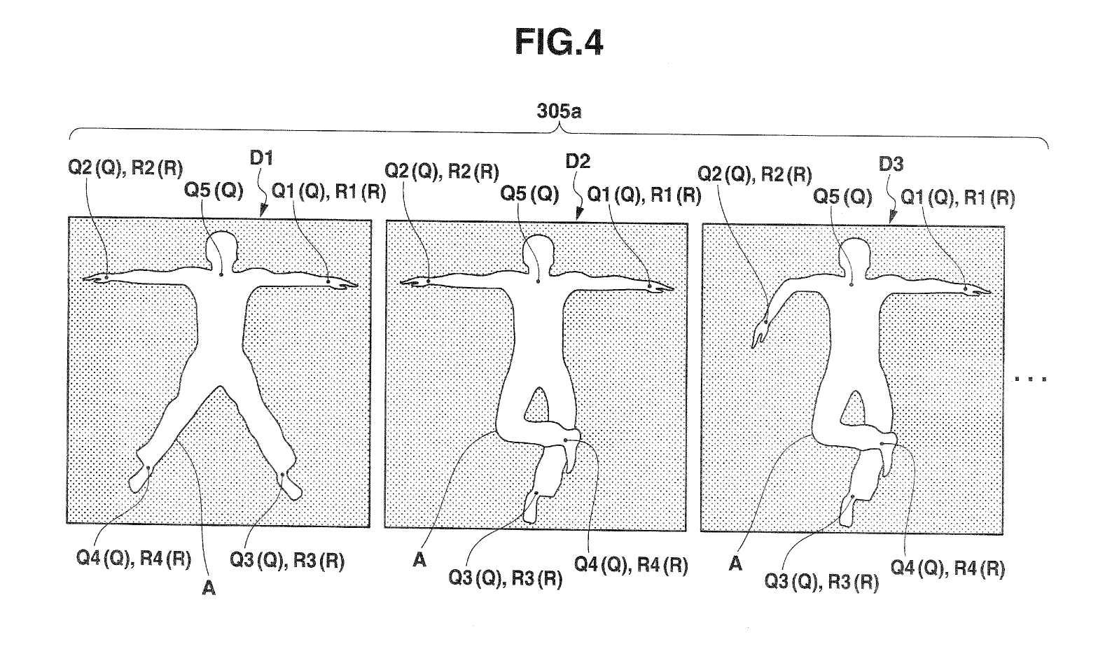

Here, positions of the respective motion reference points Q are individually defined in consideration of a skeleton shape, joint positions and the like of a moving subject model (for example, a person, an animal or the like) which becomes a model of the motions. That is to say, the respective motion reference points Q are set in a model region A, which includes a moving subject model of a reference image to serve as a reference, in consideration of the skeleton shape, joint positions and the like of the moving subject model. For example, with regard to the motion reference points Q, in the model region A of the reference image, motion reference points Q1 and Q2 of left and right wrists are set at positions respectively corresponding to left and right wrists of the person, moreover, motion reference points Q3 and Q4 of left and right ankles are set at positions respectively corresponding to left and right ankles of the person, and furthermore, a motion reference point Q5 of a neck of the person is set at a position corresponding to a neck of the person (refer to FIG. 4). Note that the number of motion reference points Q is settable appropriately and arbitrarily in response to a shape, size and the like of the moving subject model.

Here, FIG. 4 shows reference images schematically showing states when the person as the moving subject model is viewed from the front. In each of the reference images, on a left side thereof when viewed from the front, a right arm and right leg of the person as the moving subject model is arranged, and meanwhile, on a right side thereof when viewed from the front, a left arm and left leg of the person as the moving subject is arranged.

Moreover, in each piece of the motion information 305a, pieces of coordinate information, in each of which all or at least one of the plurality of motion reference points Q . . . is moved in a predetermined space, are arrayed continuously at a predetermined time interval, whereby motions of the plurality of motion reference points Q . . . for each predetermined time interval are shown continuously. Specifically, each piece of the motion information 305a is, for example, information in which the plurality of motion reference points Q . . . set in the model region A of the reference image are moved so as to correspond to a predetermined dance.

For example, as shown in FIG. 4, in each piece of the motion information 305a, such pieces of coordinate information as coordinate information D1, coordinate information D2 and coordinate information D3 are arrayed continuously at a predetermined time interval along a time axis. In the coordinate information D1, the plurality of motion reference points Q schematically show a state where the moving subject model as the person raises both arms horizontally and opens both legs. In the coordinate information D2, the plurality of motion reference points Q schematically show a state where one leg (left leg in FIG. 4) is crossed over other leg. Moreover, in the coordinate information D3, the plurality of motion reference points Q schematically show a state where one arm (left arm in FIG. 4) is lowered. In FIG. 4, illustration of coordinate information subsequent to the coordinate information D3 is omitted.

Note that the motion information 305a shown in FIG. 4 is merely an example, motion information of the present invention is not limited to this, and a type and the like of the motion are changeable appropriately and arbitrarily. Moreover, for example, each piece of the coordinate information of the plurality of motion reference points Q may be information in which movements of the respective motion reference points Q with respect to coordinate information of the motion reference point Q to serve as a reference are defined, or may be information in which absolute position coordinates of the respective motion reference points Q are defined.

Moreover, the storage unit 305 stores plural pieces of overlap position information 305b indicating positions of the plurality of overlap reference points R . . . in the two-dimensional space.

Each piece of the overlap position information 305b is information indicating positions of a plurality of the overlap reference points R . . . in the two-dimensional flat space defined by two axes (for example, the x-axis, the y-axis and the like) perpendicular to each other.

Here, each of the overlap reference points R is set for each of a plurality of regions which compose the model region A of the reference image, that is, for each of representative spots of the person as the moving subject model, and preferably, is set at a position far from a trunk. Moreover, the respective overlap reference points R may be set at positions substantially equal to the respective motion reference points Q. Specifically, for example, with regard to the respective overlap reference points R, in the model region A of the reference image, left and right wrist overlap reference positions R1 and R2 are set at positions corresponding to the respective left and right wrists of the person, and moreover, left and right ankle overlap reference positions R3 and R4 are set at positions corresponding to the respective left and right ankles of the person.

Moreover, the respective overlap reference points R are associated with reference positions (depth information) in the depth direction with respect to the two-dimensional space for each predetermined time interval. That is to say, in each piece of the overlap position information 305b, pieces of coordinate information, in each of which all or at least one of the plurality of overlap reference points R . . . is moved in the depth direction (for example, a z-axis direction or the like) with respect to the two-dimensional flat space, are arrayed continuously at a predetermined time interval, whereby reference positions in the depth direction of the plurality of overlap reference points R . . . for each predetermined time interval are shown continuously. Note that each piece of the coordinate information of the plurality of overlap reference points R may be information in which movements of the respective overlap reference points R with respect to coordinate information of the overlap reference point R to serve as a reference are defined, or may be information in which absolute position coordinates of the respective overlap reference points R are defined.

As described above, the storage unit 305 composes a storage unit that stores the plural pieces of the position information indicating the positions of the plurality of overlap reference points R in the two-dimensional space, which are set for each of the plurality of regions which compose the model region A including the moving subject model of the reference image, and are associated with the reference positions in the depth direction with respect to the two-dimensional space for each predetermined time interval.

Moreover, the storage unit 305 stores plural pieces of music information 305c for use in the animation creation processing.

Each piece of the music information 305c is information for automatically reproducing a music together with an animation by an animation reproducing unit 306i (described later) of the animation processing unit 306. That is to say, for example, the plural pieces of music 305c are defined while differentiating a tempo, a rhythm, an interval, a scale, a key, an expression mark, and the like, and are individually stored in association with titles.

Moreover, each piece of the music information 305c is digital data, for example, defined in accordance with the musical instruments digital interface (MIDI) standard and the like, and specifically, includes: header information in which the number of tracks, a resolution (number of tick counts) of a quarter note, and the like are defined; track information composed of an event and timing, which are supplied to a sound source (for example, a musical instrument and the like) assigned to each part; and the like. As the event of this track information, for example, there is information for instructing a change of the tempo or the rhythm, or instructing Note On/OFF.

The animation processing unit 306 includes: an image obtaining unit 306a; a first setting unit 306b; a second setting unit 306c; a region dividing unit 306d; a region specifying unit 306e; a depth position calculating unit 306f; a frame creating unit 306g; a back surface image creating unit 306h; and an animation reproducing unit 306i.

The image obtaining unit 306a obtains the still image for use in the animation creation processing.

That is to say, as an obtaining unit, the image obtaining unit 306a obtains the two-dimensional still image to serve as a processing target of the animation creation processing. Specifically, the image obtaining unit 306a obtains the image data of the subject clipped image, which is created by the subject clipping unit 304, and the image data of the mask image P1, which is associated with the image data of the subject clipped image concerned.

The first setting unit 306b sets the plurality of motion control points S in the subject region of the still image to serve as the processing target of the animation creation processing.

Specifically, as a first setting unit, the first setting unit 306b sets the plurality of motion control points S, which are related to the control for the motion of the subject, in the subject region of the two-dimensional still image obtained by the image obtaining unit 306a. Specifically, the first setting unit 306b individually sets the plurality of motion control points S at the respective positions, which correspond to the plurality of motion reference points Q . . . set in the model region A of the reference image, in the respective subject regions B of the subject clipped image and the mask image P1.

For example, the first setting unit 306b reads out the motion information 305a of the moving subject model (for example, a person) from the storage unit 305, and in the respective subject regions B of the subject clipped image and the mask image P1, individually sets the motion control points S (for example, motion control points S1 to S5 and the like), which respectively correspond to the plurality of motion reference points Q . . . (for example, the motion reference points Q1 to Q5 and the like) of a reference frame (for example, a first frame or the like) defined in the motion information 305a concerned, at desired positions designated based on the predetermined operation for the operation input unit 202 of the user terminal 2 by the user (refer to FIG. 11A).

Here, by individually setting the motion control points S in the subject region B of the subject clipped image, also for predetermined positions in a back surface image corresponding to the subject clipped image, the first setting unit 306b may also automatically set the motion control points S respectively corresponding thereto.

At this time, for the model region A of the moving subject model and the subject regions B of the subject clipped image and the mask image P1, for example, the first setting unit 306b may perform dimension adjustment (for example, enlargement, reduction, deformation and the like of the moving subject model) so that sizes of a main portion such as a face can be matched with one another. Moreover, for example, the first setting unit 306b may overlap the images of the model region A and the subject regions B one another, and specify positions to which the plurality of motion reference points Q in the subject regions B correspond.

Moreover, for all of the plurality of motion reference points Q . . . defined in the motion information 305a, the first setting unit 306b may set the motion control points S corresponding thereto, or alternatively, may set only the motion control points S corresponding to a predetermined number of the representative motion reference points Q, such as the center portion, respective tip end portions and the like of the subject.

Note that, in the subject regions B of the subject clipped image and the mask image P1, the first setting unit 306b may automatically specify positions to which the plurality of motion reference points Q . . . of the reference frame (for example, the first frame or the like) defined in the motion information 305a read out from the storage unit 305 respectively correspond. For example, in consideration of the skeleton shape, joint positions and the like of the subject, the first setting unit 306b specifies the positions to which the plurality of motion reference points Q . . . respectively correspond. Then, the first setting unit 306b individually sets the motion control points S at the positions to which the plurality of specified motion reference points Q . . . correspond.

Moreover, even in the case where the setting of the motion control points S by the first setting unit 306b is automatically performed, correction (change) of the setting positions of the motion control points S may be accepted based on a predetermined operation for the operation input unit by the user.

The second setting unit 306c sets the plurality of overlap control points T in the subject region B of the still image to serve as the processing target of the animation creation processing.

Specifically, in the subject region B of the two-dimensional still image obtained by the image obtaining unit 306a, as a second setting unit, the second setting unit 306c sets the plurality of overlap control points T, which are related to the overlap control for the plurality of constituent regions L . . . composing the subject region B, at the respective positions corresponding to the plurality of overlap reference points R . . . . Specifically, in the respective subject regions B of the subject clipped image and the mask image P1, the second setting unit 306c individually sets the plurality of overlap control points T at the respective positions corresponding to the plurality of overlap reference points R set for each of the plurality of regions composing the model region A of the reference image (for example, for each of the representative spots of the person as the moving subject model, and the like).

For example, the second setting unit 306c reads out the overlap position information 305b from the storage unit 305, and in the respective subject regions B of the subject clipped image and the mask image P1, individually sets the overlap control points T (for example, overlap control points T1 to T4 and the like), which respectively correspond to the plurality of overlap reference points R . . . (for example, the overlap reference points R1 to R4 and the like) of the reference frame (for example, the first frame or the like) defined in the overlap position information 305b concerned, at the desired positions designated based on the predetermined operation for the operation input unit 202 of the user terminal 2 by the user (refer to FIG. 11A). At this time, for all of the plurality of overlap reference points R . . . defined in the overlap position information 305b, the second setting unit 306c may set the overlap control points T corresponding thereto, or alternatively, may set only the overlap control points T corresponding to a predetermined number of representative overlap reference points R, such as the center portion, respective tip end portions and the like of the subject.

Moreover, while taking, as references, the setting positions of the motion control points S by the first setting unit 306b, for example, the second setting unit 306c may set the overlap control points T at positions substantially equal to the setting positions of the motion control points S. At this time, for all of the already set motion control points S, the second setting unit 306c may set the overlap control points T at the substantially equal positions, or alternatively, may set only the overlap control points T corresponding to a predetermined number of the representative motion control points S, such as the center portion, respective tip end portions and the like of the subject.

The region dividing unit 306d divides the subject region B into a plurality of image regions Ba . . . with predetermined shapes.

Specifically, for example, the region dividing unit 306d performs Delaunay triangulation for the image data of the subject clipped image and the mask image P1, arranges vertices in the subject region B at a predetermined interval, and divides the subject region B into the plurality of triangular mesh-like image regions Ba . . . (refer to FIG. 11B). Here, the vertices of the image regions Ba may be set at positions substantially equal to the motion control points S and the overlap control points T, or may be set at positions different therefrom.

Note that the Delaunay triangulation refers to a method of dividing a region as a processing target so that a sum of minimum angles of a plurality of triangles in which the respective points are taken as vertices can be made maximum among methods of dividing the region concerned into the triangles concerned.

Moreover, though the Delaunay triangulation is illustrated as the method of dividing the subject region B by the region dividing unit 306d, the Delaunay triangulation is merely an example, and such a dividing method of the present invention is not limited to this, and the dividing method is changeable appropriately and arbitrarily as long as the dividing method is a method of dividing the subject region B into the plurality of image regions Ba . . . .

For each of the plurality of overlap control points T, the region specifying unit 306e specifies the plurality of constituent regions L which compose the subject region B.

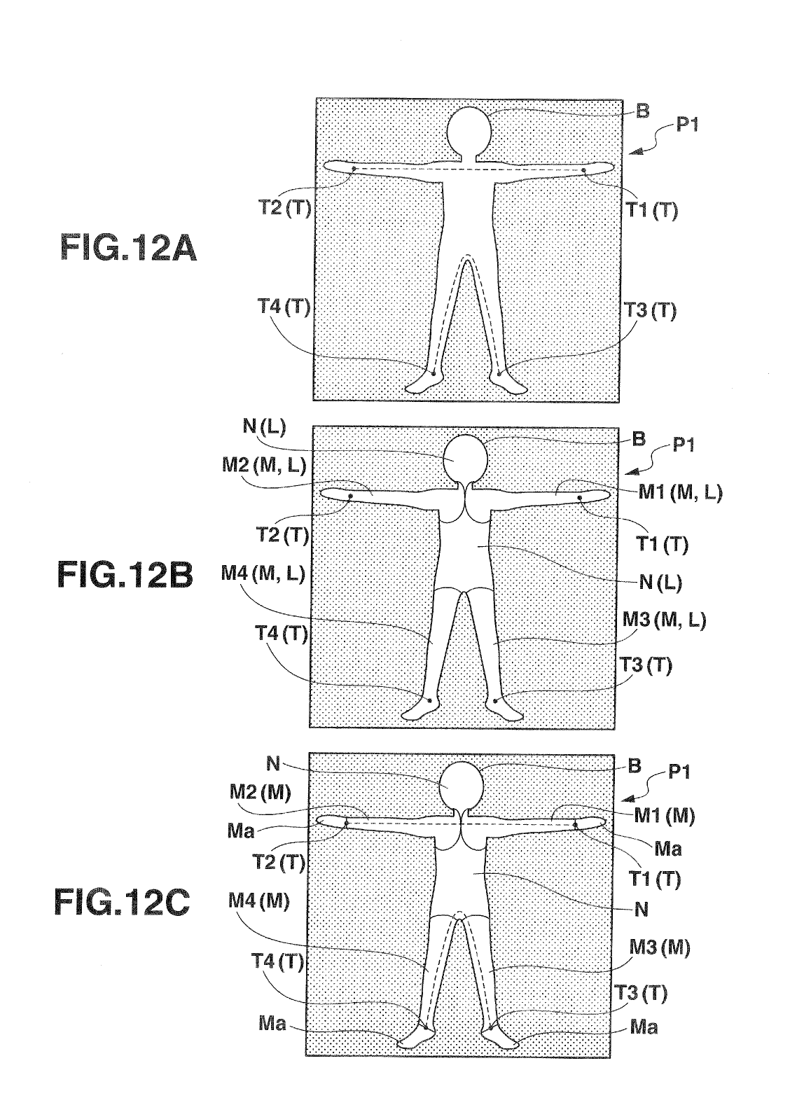

That is to say, for each of the plurality of overlap control points T set by the second setting unit 306c, while taking, as a reference, a distance to other overlap control point T existing at a nearest position, the region specifying unit 306e specifies a plurality of overlap control regions M as the constituent regions L in the subject region of the mask image P1. Specifically, for each of the overlap control points T (for example, the left wrist overlap control point T1 and the like), for example, by using the Dijkstra's algorithm and the like, the region specifying unit 306e specifies the other overlap control point T (for example, the right wrist overlap control point T2 and the like) existing at a nearest position on a route along edge portions of the plurality of image regions Ba . . . (for example, the triangular image regions Ba) obtained by the division of the subject region B by the region dividing unit 306d (refer to FIG. 12A). Then, for each of the overlap control points T, the region specifying unit 306e specifies a region, which is composed of the plurality of image regions Ba . . . existing within a distance as a half of the distance to the specified other overlap control point T existing at the nearest position, as the overlap control region M of the overlap control point T concerned (refer to FIG. 12B). For example, the region specifying unit 306e individually specifies a left arm overlap control region M1 related to the left wrist overlap control point T1, a right arm overlap control region M2 related to the right wrist overlap control point T2, a left leg overlap control region M3 related to the left ankle overlap control point T3, a right leg overlap control region M4 related to the right ankle overlap control point T4, and the like.

Note that, in FIG. 12A, and FIG. 12C to be described later, illustration of the plurality of image regions Ba . . . obtained by the division of the subject region B is omitted, and distances between the overlap control points T are schematically shown by broken lines.

Moreover, the region specifying unit 306e specifies non-overlap control regions N, which are other than the plurality of overlap control regions M . . . in the subject region B, as constituent regions L.

Specifically, the region specifying unit 306e specifies regions of portions, which remain as a result of that the overlap control regions M are specified in the subject region B of the mask image P1, as the non-overlap control regions N. Specifically, for example, the region specifying unit 306e specifies the respective regions mainly corresponding to a body and a head, which are the regions of the portions remaining as a result of that the left and right arm overlap control regions M1 and M2 and the left and right leg overlap control regions M3 and M4 are specified in the subject region B of the mask image P1, as the non-overlap control regions N (refer to FIG. 12B).

That is to say, the non-overlap control region N corresponding to the body becomes a region relatively on a center side of the subject region B, and the plurality of overlap control regions M become regions relatively on end portion sides of the subject region B concerned, the regions being adjacent to the non-overlap control region N.

Note that the method of specifying the overlap control regions M and the non-overlap control regions N by the region specifying unit 306e is merely an example, and such a specifying method of the present invention is not limited to this, and is changeable appropriately and arbitrarily.

The depth position calculating unit 306f calculates a position in the depth direction of each of the plurality of constituent regions L . . . for each predetermined time interval, which compose the subject region B.

Specifically, as a calculating unit, the depth position calculating unit 306f calculates the position in the depth direction of each of the plurality of constituent regions L . . . for each predetermined time interval based on the reference position (depth information) in the depth direction of the overlap reference point R corresponding to each of the plurality of overlap control points T . . . . Specifically, the depth position calculating unit 306f calculates the position in the depth direction of each of the plurality of overlap control regions M . . . for each predetermined time interval, which are specified by the region specifying unit 306e, based on the reference position of the overlap reference point R in the depth direction with respect to the two-dimensional space for each predetermined time interval, the overlap reference point R corresponding to the overlap control point T related to each of the overlap control regions M. For example, the depth position calculating unit 306f reads out the overlap position information 305b from the storage unit 305, and obtains a reference position of the overlap reference point R in the depth direction with respect to the two-dimensional space for each predetermined time interval, the overlap reference point R having each of the overlap control points T associated therewith by the second setting unit 306c. Then, based on the obtained reference position of the overlap reference point R in the depth direction with respect to the two-dimensional space for each predetermined time interval, the depth position calculating unit 306f calculates a position of each of the overlap control regions M in the depth direction for each predetermined time interval, each overlap control region M being related to the overlap control point T corresponding to the overlap reference point R, so that pixels of the respective vertices of the plurality of image regions Ba . . . which compose each overlap control region M cannot overlap one another in a predetermined direction (for example, a direction from the end portion side of the subject region B to the center portion side thereof).

Here, for each of the plurality of overlap control regions (constituent regions L) M . . . , the depth position calculating unit 306f may calculate a position in the depth direction of each vertex of the plurality of image regions Ba . . . , which are obtained by dividing each of the overlap control regions M by the region dividing unit 306d, while taking, as a reference, a distance thereto from the overlap control point T related to each of the overlap control regions M concerned.

For example, for each of the plurality of overlap control regions (constituent regions L) M . . . , the depth position calculating unit 306f calculates depth normalization information in which a position of each vertex of the plurality of image regions Ba . . . is normalized by a value within a range of “0” to “1”. Specifically, the depth position calculating unit 306f calculates such depth normalization information in which the value concerned becomes “1” at the position of the overlap control point T, becomes gradually smaller as the position is being separated from the overlap control point T, and becomes “0” at a position of a vertex (vertex on an opposite side to the overlap control point T of the overlap control region M) existing at a farthest position.

Moreover, in each of the overlap control regions M, in a similar way to the overlap control point T, the depth position calculating unit 306f sets, at “1”, depth normalization information of each vertex of a predetermined number of image regions Ba existing in a region Ma on an opposite side to the direction directed from the overlap control point T concerned to the other overlap control point T existing at the nearest position while taking the overlap control point T as a reference (refer to FIG. 12C). Here, in each of the overlap control regions M, the depth position calculating unit 306f may set, at “1”, depth normalization information of each vertex existing within a predetermined distance (for example, approximately ⅕ of a longest route that can be taken in the overlap control region M) while taking the overlap control point T as a reference.

Moreover, the depth position calculating unit 306f calculates a position in the depth direction of each non-overlap control region N for each predetermined time interval, the non-overlap control region N being specified by the region specifying unit 306e, so that the respective pixels composing the non-overlap control region N can be located at positions different from one another in the depth direction.

That is to say, for the non-overlap control regions N, the depth position calculating unit 306f calculates depth normalization information in which a position of each vertex of the plurality of image regions Ba . . . is normalized by a value within the range of “0” to “1”. Specifically, for example, the depth position calculating unit 306f normalizes the respective vertices of the plurality of image regions Ba along the y-axis direction (up and down direction), and calculates the depth normalization information so that a position of such a vertex existing in an uppermost portion (for example, on the head side) can be “1”, and that a position of such a vertex existing in a lowermost portion (for example, on the leg side) can be “0”.

Then, while taking the positions in the depth direction of the non-overlap control regions N as references, the depth position calculating unit 306f calculates positions in the depth direction of the plurality of overlap control regions M.

That is to say, for example, the depth position calculating unit 306f sets, at “0”, a position in the depth direction of an arbitrary point (non-overlap control point) of each non-overlap control region N, reads out the overlap position information 305b from the storage unit 305, and obtains the reference positions in the depth direction of the overlap reference points R corresponding to the overlap control points T related to the plurality of respective overlap control regions M . . . . Thereafter, the depth position calculating unit 306f sorts the plurality of overlap control points T . . . and the non-overlap control point in accordance with a predetermined rule. For example, in terms of contents, in the case where the overlap position information 305b defines “100” as the reference position in the depth direction of the left wrist overlap reference point R1 corresponding to the left wrist overlap control point T1, defines “20” as the reference position in the depth direction of the right wrist overlap reference point R2 corresponding to the right wrist overlap control point T2, defines “−50” as the reference position in the depth direction of the left ankle overlap reference point R3 corresponding to the left ankle overlap control point T3, and defines “−70” as the reference position in the depth direction of the right ankle overlap reference point R4 corresponding to the right ankle overlap control point T4, then the depth position calculating unit 306f sorts the control points concerned in order of the left wrist overlap control point T1, the right wrist overlap control point T2, the non-overlap control point, the left ankle overlap control point T3, and the right ankle overlap control point T4.

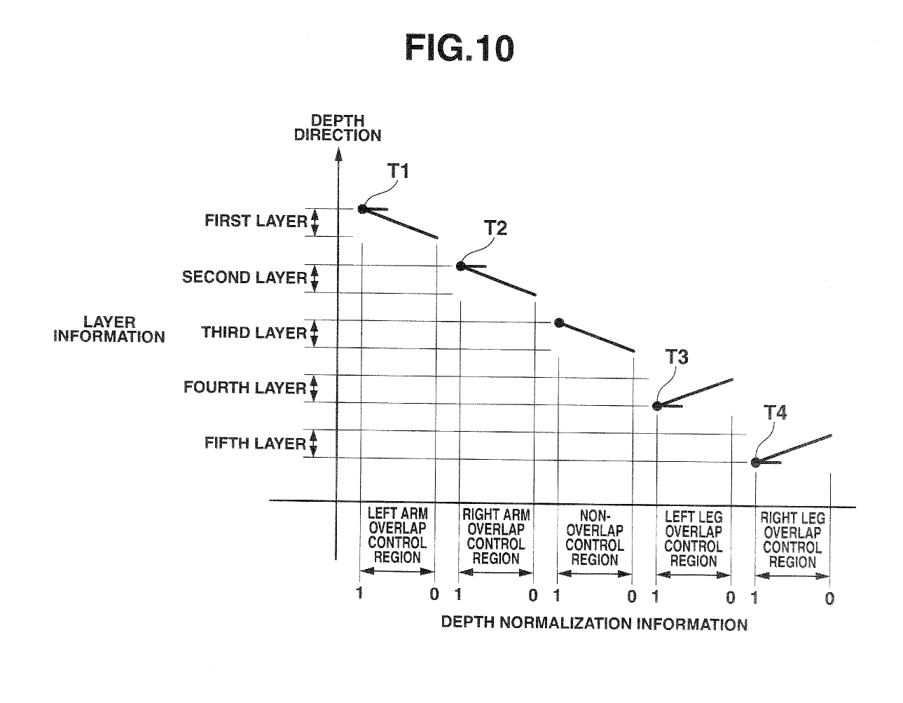

Then, in order of the left arm overlap control region M1 related to the left wrist overlap control point T1, the right arm overlap control region M2 related to the right wrist overlap control point T2, the non-overlap control regions N related to the non-overlap control points, the left leg overlap control region M3 related to the left ankle overlap control point T3, and the right leg overlap control region M4 related to the right ankle overlap control point T4, the depth position calculating unit 306f assigns the control regions concerned to a predetermined number of layers (for example, first to fifth layers; refer to FIG. 10).

Here, the predetermined number of layers are set at positions different from one another in the depth direction (so as not to overlap one another), and take values in the depth direction, which are actually used in the event where frame images are drawn (refer to FIG. 10). Moreover, with regard to the depth direction of the predetermined number of layers, a length (thickness) of the direction concerned is set at a value at which the length concerned is not conspicuous in a state of the frame images so that the still image as the processing target can look like a two-dimensional still image.

Moreover, based on the depth normalization information of the left art overlap control region M1, the right arm overlap control region M2, the non-overlap control regions N, the left leg overlap control region M3 and the right leg overlap control region M4, the depth position calculating unit 306f calculates positions in the depth direction of the respective vertices of the respective constituent regions L.

Specifically, the depth position calculating unit 306f determines whether or not the reference position in the depth direction of the overlap reference point R corresponding to the overlap control region M to serve as the processing target is larger than the position “0” in the depth direction of the non-overlap control regions N, and in response to a result of the determination concerned, switches and sets general expressions for calculating the positions in the depth direction.

For example, as in the left arm overlap control region M1 or the right arm overlap control region M2, in the case where the reference position in the depth direction of the overlap reference point R is smaller than the position “0” in the depth direction of the non-overlap control regions N, then the depth position calculating unit 306f calculates a position “Zpos” in the depth direction of each vertex of the image region Ba in the layer, the image region Ba composing each of the overlap control regions M, based on the following Expression A. In a similar way, with regard to each non-overlap control region N, the depth position calculating unit 306f calculates a position “Zpos” in the depth direction of each vertex of the image region Ba in the layer, the image region Ba composing the non-overlap control region N, based on the following Expression A:

Zpos=“depth normalization information”*“LayerW”+“LayerMin” Expression A

Moreover, as in the left leg overlap control region M3 or the right leg overlap control region M4, in the case where the reference position in the depth direction of the overlap reference point R is larger than the position “0” in the depth direction of the non-overlap control region N, then the depth position calculating unit 306f calculates a position “Zpos” in the depth direction of each vertex of the image region Ba in the layer, the image region Ba composing each of the overlap control regions M, based on the following Expression B:

Zpos=(1−“depth normalization information”)*“LayerW”+“LayerMin” Expression B

Here, “LayerW” in the foregoing Expressions A and B represents a difference (width) between a maximum value “LayerMax” and minimum value “LayerMin” of a depth distance (width) that can be taken for each of the corresponding layers.

Note that such a method of calculating the positions in the depth direction of the respective vertices of the respective constituent regions L by the depth position calculating unit 306f is merely an example, and such a calculation method of the present invention is not limited to this, and is changeable appropriately and arbitrarily.

The frame creating unit 306g sequentially creates a plurality of reference frame images which compose the animation.

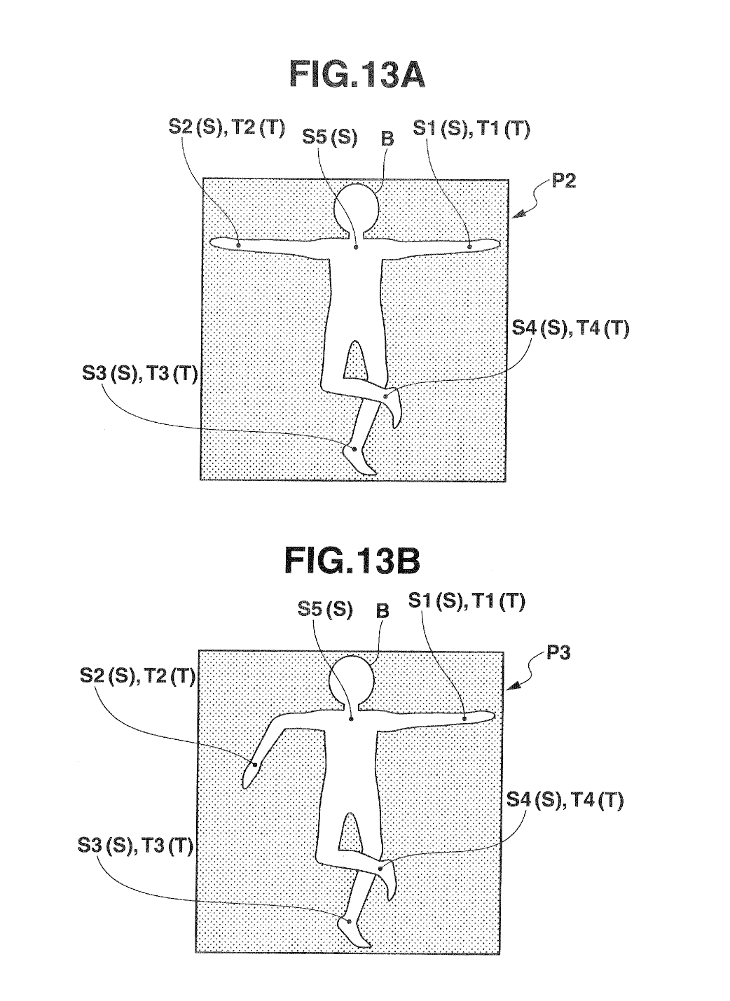

That is to say, the frame creating unit 306g moves the plurality of motion control points S set in the subject region B of the subject clipped image so as to allow the motion control points S concerned to follow the motions of the plurality of motion reference points Q . . . of the motion information 305a designated by the animation processing unit 306, and sequentially creates the plurality of reference frame images (refer to FIG. 13A and FIG. 13B). Specifically, for example, the frame creation unit 306g sequentially obtains the coordinate information of the plurality of motion reference points Q . . . which move at a predetermined time interval in accordance with the motion information 305a, and calculates coordinates of the respective motion control points S respectively corresponding to the motion reference points Q. Then, the frame creation unit 306g sequentially moves the motion control points S to the calculated coordinates, in addition, moves and deforms the plurality of image regions (for example, the triangular mesh-like regions) Ba . . . obtained by the division of the subject region B by the region obtaining unit 306d, and thereby creates the reference frame images (not shown).

At this time, as a creating unit, the frame creating unit 306g displaces the respective constituent regions L in the subject region B for each predetermined time interval in the depth direction at positions different from one another in the depth direction concerned based on the positions “Zpos” in the depth direction of the plurality of constituent regions L for each predetermined time interval, the positions “Zpos” being calculated by the depth position calculating unit 306f. In addition, the frame creating unit 306g creates reference frame images (deformed images) obtained by deforming the subject region B in accordance with the motions of the plurality of motion control points S. Specifically, for example, by using a three-dimensional drawing interface such as Open GL, the frame creating unit 306g displaces the respective constituent regions L in the subject region B of the subject clipped image for each predetermined time interval in the depth direction at the positions different from one another in the depth direction concerned based on the position “Zpos” in the depth direction for each predetermined time interval of each of the plurality of overlap control regions M . . . and each non-overlap control region N, which are the constituent regions L composing the subject region B.

Note that such processing for moving and deforming the predetermined image regions Ba while taking the motion control points S as references is a technology known in public, and accordingly, a detailed description thereof is omitted here.

Moreover, FIG. 13A and FIG. 13B schematically show mask images P2 and P3 corresponding to the already deformed reference frame images. FIG. 13A is a view of the plurality of motion reference points Q . . . of the motion information 305a, which correspond to the coordinate information D2, and FIG. 13B is a view of the plurality of motion reference points Q . . . of the motion information 305a, which correspond to the coordinate information D3.

Moreover, the mask images P2 and P3 shown in FIG. 13A and FIG. 13B schematically show states where two legs are crossed over each other so as to correspond to the already deformed reference frame images. In other words, in the already deformed reference frame images, such crossed portions are located so as to overlap each other fore and aft; however, in the two-dimensional mask images P2 and P3, in actual, a fore and aft relationship between the legs is not expressed.

Moreover, the frame creating unit 306g creates interpolation frame images (not shown), each of which interpolates between two reference frame images created based on the plurality of motion control points S . . . . respectively corresponding to the already moved motion reference points Q, the two adjacent reference frames being adjacent to each other along the time axis. That is to say, the frame creating unit 306g creates a predetermined number of the interpolation frame images, each of which interpolates between two reference frames, so that the plurality of frame images can be playd at a predetermined frame rate (for example, 30 fps and the like) by the animation reproducing unit 306i.

Specifically, in the two reference frame images adjacent to each other, the frame creating unit 306 sequentially obtains a playing progress degree of a predetermined music to be playd by the animation reproducing unit 306i, and in response to the progress degree concerned, sequentially creates the interpolation frame image to be playd between the two reference frames adjacent to each other. For example, the frame creating unit 306g obtains tempo setting information and the resolution (number of tick counts) of the quarter note based on the music information 305c according to the MIDI standard, and converts an elapsed time of the playing of the predetermined music to be playd by the animation reproducing unit 306i into the number of tick counts. Subsequently, based on the number of tick counts corresponding to the elapsed time of the playing of the predetermined music, the frame creating unit 306g calculates a relative progress degree of the playing of the predetermined music between the two reference frame images which are adjacent to each other and are synchronized with predetermined timing (for example, a first beat of each bar, and the like), for example, by a percentage. Then, in response to the relative progress degree of the playing of the predetermined music, the frame creating unit 306g changes weighting to the two reference frame images concerned adjacent to each other, and creates the interpolation frame images.

Note that such processing for creating the interpolation frame images is a technology known in public, and accordingly, a detailed description thereof is omitted here.

Moreover, the creation of the reference frame images and the interpolation frame images by the frame creating unit 306g is performed also for the image data of the mask image P1 and the alpha map in a similar way to the above.

The back surface image creating unit 306h creates the back surface image (not shown) that shows a back side (back surface side) of the subject in a pseudo manner.

That is to say, the back surface image creating unit 306h draws a subject corresponding region corresponding to the subject region of the subject clipped image in the back surface image, for example, based on color information of an outline portion of the subject region of the subject clipped image.

The animation reproducing unit 306i plays each of the plurality of frame images created by the frame creating unit 306g.

That is to say, the animation reproducing unit 306i automatically plays the predetermined music based on the music information 305c designated based on a predetermined operation for the operation input unit 202 of the user terminal 2 by the user, and in addition, plays each of the plurality of frame images at the predetermined timing of the predetermined music. Specifically, the animation reproducing unit 306i converts the digital data of the music information 305c of the predetermined music into the analog data by the D/A converter, and automatically plays the predetermined music. At this time, the animation reproducing unit 306i plays the two reference frame images adjacent to each other so that the reference frame images can be synchronized with the predetermined timing (for example, the first beat and respective beats of each bar, and the like), and in addition, in response to the relative progress degree of the playing of the predetermined music between the two reference frame images adjacent to each other, plays each of the interpolation frame images corresponding to the progress degree concerned.

Note that the animation reproducing unit 306i may play a plurality of the frame images, which are related to the subject image, at a speed designated by the animation processing unit 306. In this case, the animation reproducing unit 306i changes the timing for synchronizing the two reference frame images adjacent to one another therewith, thereby changes the number of frame images to be playd within a predetermined unit time, and varies a speed of the motion of the subject image.

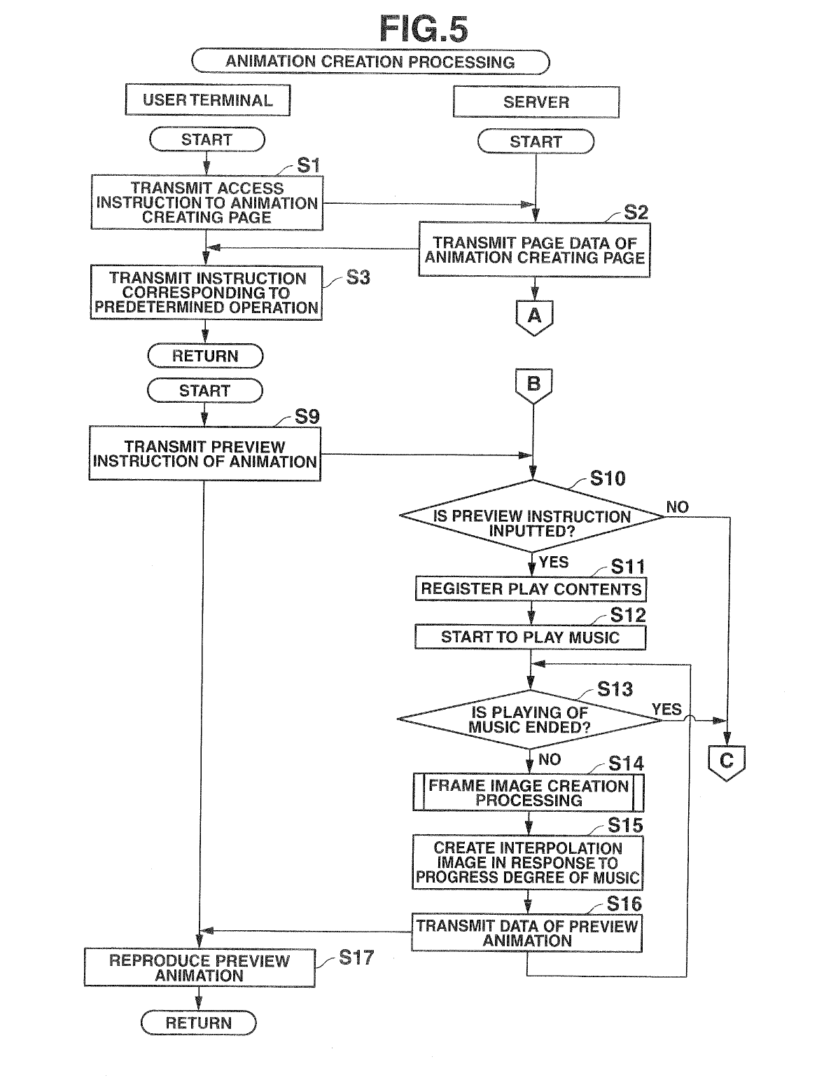

Next, a description is made of the animation creation processing, which uses the user terminal 2 and the server 3, with reference to FIG. 5 to FIG. 12.

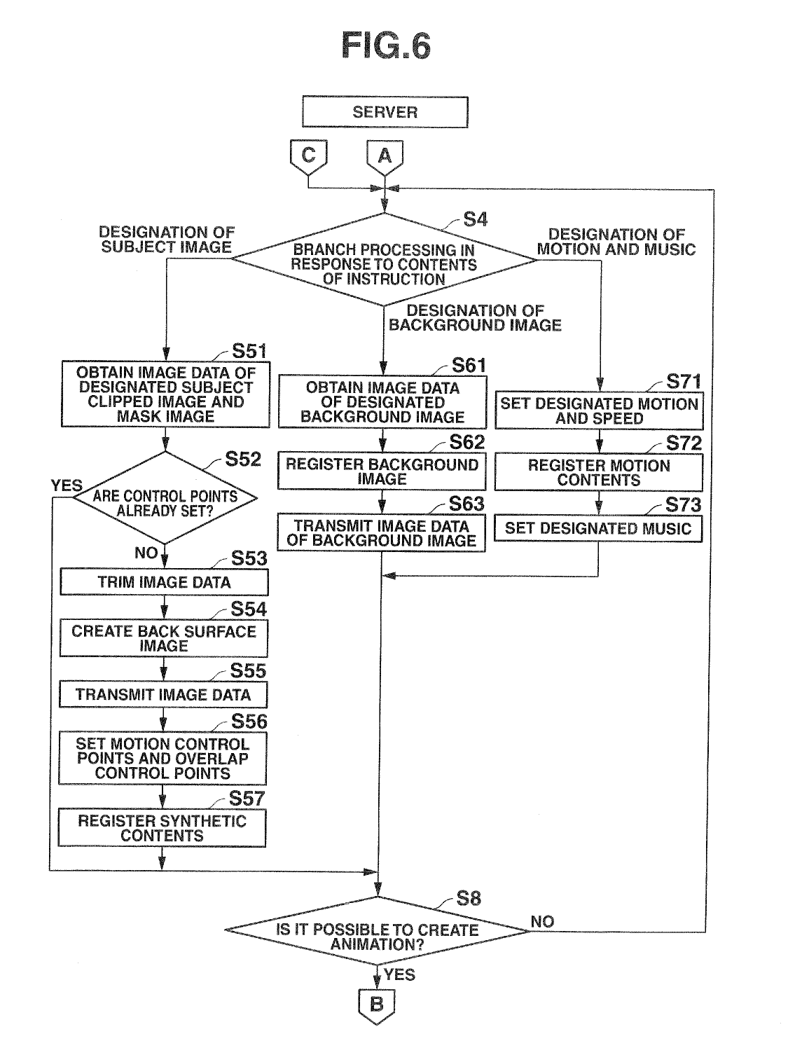

Here, FIG. 5 and FIG. 6 are flowcharts showing an example of operations related to the animation creation processing.

Note that, in the following description, it is assumed that the image data of the subject clipped image, which is created from the image data of the subject existing image, and the image data of the mask image P1, which corresponds to the subject clipped image concerned, are stored in the storage unit 305 of the server 3.

As shown in FIG. 5, upon receiving an input of an access instruction to the animation creating page, which is to be established by the server 3, the input being made based on a predetermined operation for the operation input unit 202 by the user, the CPU of the central control unit 201 of the user terminal 2 transmits the access instruction concerned to the server 3 through the predetermined communication network N by the communication control unit 206 (Step S1).

When the access instruction, which is transmitted from the user terminal 2, is received by the communication control unit 303 of the server 3, the CPU of the central control unit 301 transmits the page data of the animation creating page to the user terminal 2 through the predetermined communication network N by the communication control unit 303 (Step S2).

Then, when the page data of the animation creating page is received by the communication control unit 206 of the user terminal 2, the display unit 203 displays a screen (not shown) of the animation creating page based on the page data of the animation creating page.

Next, based on a predetermined operation for the operation input unit 202 by the user, the central control unit 201 of the user terminal 2 transmits an instruction signal, which corresponds to each of various buttons operated in the screen of the animation creating page, to the server 3 through the predetermined communication network N by the communication control unit 206 (Step S3).

As shown in FIG. 6, the CPU of the central control unit 301 of the server 3 branches the processing in response to contents of the instruction from the server 3 (Step S4). Specifically, in the case where the instruction from the user terminal 2 has contents regarding designation of the subject image (Step S4: designation of the subject image), the CPU of the central control unit 301 shifts the processing to Step S51. Moreover, in the case where the instruction concerned has contents regarding designation of the background image (Step S4: designation of the background image), the CPU concerned shifts the processing to Step S61. Furthermore, in the case where the instruction concerned has contents regarding designation of the motion and the music (Step S4: designation of the motion and the music), the CPU concerned shifts the processing to Step S71.

### <Designation of Subject Image>

In the case where, in Step S4, the instruction from the user terminal 2 has the contents regarding the designation of the subject image (Step S4: designation of the subject image), then from among the image data of the subject clipped image, which is stored in the storage unit 305, the image obtaining unit 306a of the animation processing unit 306 reads out and obtains the image data of the subject clipped image designated by the user, and the image data of the mask image P1, which is associated with the image data of the subject clipped image concerned (Step S51).

Next, the animation processing unit 306 determines whether or not the motion control points S and the overlap control points T are already set in the subject regions B of the obtained subject clipped image and mask image P1 (Step S52).

In the case where, in Step S52, it is determined that the motion control points S and the overlap control points T are not set (Step S52: NO), then based on the image data of the subject clipped image and the mask image P1, the animation processing unit 306 performs trimming for the subject clipped image and the mask image P1 while taking a predetermined position (for example, a center position or the like) of the subject region B as a reference, and thereby corrects the subject region B and the model region A of the moving subject model so that sizes thereof can become equal to each other (Step S53).

Note that the trimming is performed also for the alpha map associated with the image data of the subject clipped image.

Thereafter, the animation processing unit 306 performs back surface image creation processing for creating the back surface image (not shown) that shows the back side of the image of the subject region B of the image already subjected to the trimming in the pseudo manner (Step S54).

Next, the CPU of the central control unit 301 transmits the image data of the subject clipped image, which is associated with the created back surface image, to the user terminal 2 through the predetermined communication network N by the communication control unit 303 (Step S55). Thereafter, the animation processing unit 306 sets the pluralities of motion control points S and overlap control points T in the respective subject regions B of the subject clipped image and the mask image P1 (Step S56).

Specifically, the first setting unit 306b of the animation processing unit 306 reads out the motion information 305a of the moving subject model (for example, a person) from the storage unit 305, and in the respective subject regions B of the subject clipped image and the mask image P1, individually sets the motion control points S, which correspond to the plurality of respective motion reference points Q . . . of the reference frame (for example, the first frame and the like) set in the motion information 305a concerned, at the desired positions designated based on the predetermined operation for the operation input unit 202 of the user terminal 2 by the user (refer to FIG. 11A). Moreover, while taking the setting positions of the motion control points S by the first setting unit 306b as references, for example, the second setting unit 306c of the animation processing unit 306 sets the predetermined number of overlap control points T at the positions substantially equal to the setting positions of the motion control points S set at the tip end portions and the like of the subject region B.

For example, as shown in FIG. 11A, in the respective subject regions B of the subject clipped image and the mask image P1, the first setting unit 306b sets the left and right wrist motion control points S1 and S2 respectively corresponding to the left and right wrist motion reference points Q1 and Q2, the left and right ankle motion control points S3 and S4 respectively corresponding to the left and right ankle motion reference points Q3 and Q4, and the neck motion control point S5 corresponding to the neck motion reference point Q5. Moreover, in the respective subject regions B of the subject clipped image and the mask image P1, for example, the second setting unit 306c sets the left and right wrist overlap control points T1 and T2 respectively corresponding to the left and right wrist overlap reference points R1 and R2, and the left and right ankle overlap control points T3 and T4 respectively corresponding to the left and right ankle overlap control reference points R3 and R4.

Then, the animation reproducing unit 306i registers the motion control points S and the overlap control points T, which are set for the subject region B concerned, and in addition, synthetic contents such as synthetic positions, sizes and the like of the subject images in a predetermined storage unit (for example, a predetermined memory and the like) (Step S57).

Thereafter, the CPU of the central control unit 301 shifts the processing to Step S8. Contents of processing of Step S8 will be described later.

Note that, when it is determined in Step S52 that the motion control points S and the overlap control points T are already set (Step S52: YES), the CPU of the central control unit 310 skips the processing of Step S53 to S57, and shifts the processing to Step S8. The contents of the processing of Step S8 will be described later.

### <Designation of Background Image>

In the case where, in Step S4, the instruction from the user terminal 2 has the contents regarding the designation of the background image (Step S4: designation of the background image), the animation reproducing unit 306i of the animation processing unit 306 reads out and obtains a desired background image (other image) based on a predetermined operation for the operation input unit 202 by the user (Step S61), and registers image data of the background image concerned as the background of the animation in the predetermined storage unit (Step S62).

Specifically, a designation instruction for any one piece of image data among the plurality of image data in the screen of the animation creating page displayed on the display unit 203 of the user terminal 2, the one piece of image data being designated based on a predetermined operation for the operation input unit 202 by the user, is inputted to the server 3 through the communication network N and the communication control unit 303. The animation reproducing unit 306i reads out and obtains such image data of the background image related to the designation instruction concerned from the storage unit 305, and thereafter, registers the image data of the background image concerned as the background of the animation.

Next, the CPU of the central control unit 301 transmits the image data of the background image to the user terminal 2 through the predetermined communication network N by the communication control unit 303 (Step S63).

Thereafter, the CPU of the central control unit 301 shifts the processing to Step S8. The contents of the processing of Step S8 will be described later.

### <Designation of Motion and Music>

In the case where, in Step S4, the instruction from the user terminal 2 has the contents regarding the designation of the motion and the music (Step S4: designation of the motion and the music), the animation processing unit 306 sets the motion information 305a and the speed of the motion based on a predetermined operation for the operation input unit 202 by the user (Step S71).

Specifically, a designation instruction for any one model name (for example, a hula and the like) among model names of a plurality of motion models in the screen of the animation creating page displayed on the display unit 203 of the user terminal 2, the one model name being designated based on a predetermined operation for the operation input unit 202 by the user, is inputted to the server 3 through the communication network N and the communication control unit 303. The animation processing unit 306 sets the motion information 305a, which is associated with the model name of the motion model related to the designation instruction concerned, among the plural pieces of motion information 305a . . . stored in the storage unit 305. Note that, among the plural pieces of motion information 305a, for example, the animation processing unit 306 may automatically designate the motion information 305a set as a default and the motion information 305a designated previously.

Moreover, a designation instruction for any one speed (for example, a standard (unity magnification) and the like) among a plurality of motion speeds (for example, ½ time, standard, twice and the like) in the screen of the animation creating page displayed on the display unit 203 of the user terminal 2, the one speed being designated based on a predetermined operation for the operation input unit 202 by the user, is inputted to the server 3 through the communication network N and the communication control unit 303. The animation processing unit 306 sets the speed, which is related to the designation instruction concerned, as the speed of the motion of the subject image.

Thereafter, the animation reproducing unit 306i of the animation processing unit 306 registers the set motion information 305a and motion speed as contents of the motion of the animation in the predetermined storage unit (Step S72).

Next, the animation processing unit 306 sets the music, which is to be automatically playd, based on a predetermined operation for the operation input unit 202 by the user (Step S73).

Specifically, a designation instruction for any one music name among a plurality of music names in the screen of the animation creating page displayed on the display unit 203 of the user terminal 2, the one music name being designated based on a predetermined operation for the operation input unit 202 by the user, is inputted to the server 3 through the communication network N and the communication control unit 303. The animation processing unit 306 sets a music of the music name related to the designation instruction concerned.

Thereafter, the CPU of the central control unit 301 shifts the processing to Step S8. The contents of the processing of Step S8 will be described later.

In Step S8, the CPU of the central control unit 301 determines whether or not it is possible to create the animation in this state (Step S8). That is to say, the CPU of the central control unit 301 determines whether or not it is possible to create the animation in this state as a result of that a preparation to create the animation is made by performing registration of the motion control points S and the overlap control points S for the subject regions B, registration of the motion contents of the images of the subject regions B, registration of the background image, and the like based on the predetermined operations for the operation input unit 202 by the user.

Here, when it is determined that it is not possible to create the animation in this state (Step S8: NO), the CPU of the central control unit 301 returns the processing to Step S4, and branches the processing in response to the contents of the instruction from the user terminal 2 (Step S4).

Meanwhile, when it is determined that it is possible to create the animation in this state (Step S8: YES), then as shown in FIG. 4, the CPU of the central control unit 301 shifts the processing to Step S10.

In Step S10, the CPU of the central control unit 301 of the server 3 determines whether or not a preview instruction of the animation is inputted based on a predetermined operation for the operation input unit 202 of the user terminal 2 by the user (Step S10).

That is to say, in Step S9, the central control unit 201 of the user terminal 2 transmits the preview instruction of the animation, which is inputted based on the predetermined operation for the operation input unit 202 by the user, to the server 3 through the predetermined communication network N by the communication control unit 206 (Step S9).

Then, when the CPU of the central control unit 301 of the server 3 determines in Step S10 that the preview instruction of the animation is inputted (Step S10: YES), the animation reproducing unit 306i of the animation processing unit 306 registers, in the predetermined storage unit, the music information 305c, which corresponds to the already set music name, as the information to be automatically playd together with the music information 305c (Step S11).

Next, The animation processing unit 306 starts to play the predetermined music by the animation reproducing unit 306i based on the music information 305c registered in the storage unit (Step S12). Subsequently, the animation processing unit 306 determines whether or not such playing of the predetermined music by the animation reproducing unit 306i is ended (Step S13).

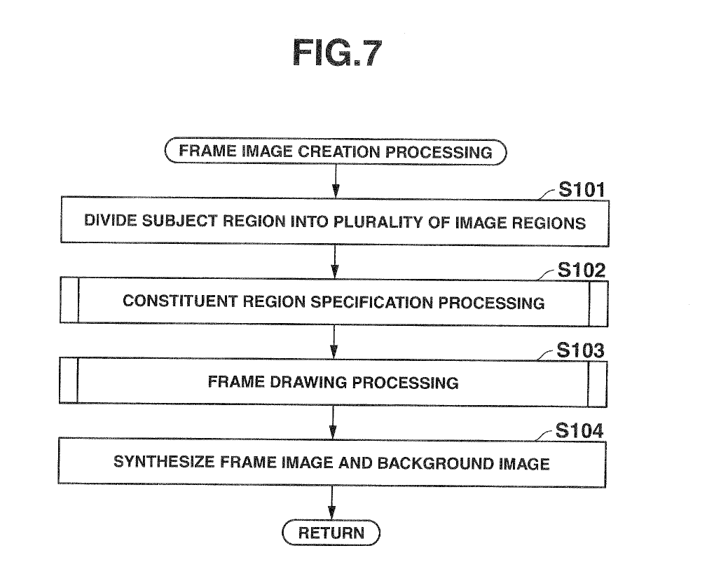

Here, when it is determined that the playing of the music is not ended (Step S13: NO), the animation processing unit 306 executes frame image creation processing (refer to FIG. 7) for creating the reference frame images (Step S14).

Note that the frame image creation processing will be described later.

Subsequently, in response to the playing progress degree of the predetermined music to be playd by the animation reproducing unit 306i, the frame creating unit 306g creates the interpolation frame image that interpolates between two reference frame images adjacent to each other (Step S15).

Moreover, the animation processing unit 306 synthesizes the interpolation frame image and the background image with each other by using a publicly known image synthesis method in a similar way to the case of the foregoing reference frame images (described later in detail).

Next, together with the music information 305c of the music to be automatically playd by the animation reproducing unit 306i, the CPU of the central control unit 301 transmits data of a preview animation composed of the reference frame images and the interpolation frame images, which are to be playd at predetermined timing of the music concerned, to the user terminal 2 through the predetermined communication network N by the communication control unit 303 (Step S16). Here, the data of the preview animation composes an animation in which a plurality of the frame images made of a predetermined number of the reference frame images and a predetermined number of the interpolation frames and the background image desired by the user are synthesized with each other.

Next, the animation processing unit 306 returns the processing to Step S13, and determines whether or not the playing of the music is ended (Step S13).

The foregoing processing is repeatedly executed until it is determined that the playing of the music is ended in Step S13 (Step S13: YES).

Then, when it is determined that the playing of the music is ended (Step S13: YES), as shown in FIG. 6, the CPU of the central control unit 301 returns the processing to Step S4, and branches the processing in response to the contents of the instruction from the user terminal 2 (Step S4).

When the data of the preview animation transmitted from the server 3 is received by the communication control unit 303 of the user terminal 2, the CPU of the central control unit 201 controls the sound output unit 204 and the display unit 203 to play the preview animation (Step S17).

Specifically, based on the music information 305c, the sound output unit 204 automatically plays the music and emits the sound from the speaker, and the display unit 203 displays the preview made of the reference frame images and the interpolation frame images on the display screen at the predetermined timing of the music concerned to be automatically playd.

Note that, in the animation creation processing described above, the preview animation is playd; however, the playing of the preview animation is merely an example, and a playing target of the present invention is not limited to this. For example, such a configuration as follows may be adopted. The image data of the reference frame images and the interpolation frame images, which are sequentially created, and of the background image, and the music information 305c, are integrated as one file, and are stored in the predetermined storage unit, and after the creation of all the data related to the animation is completed, the file concerned is transmitted from the server 3 to the user terminal 2, and is playd in the user terminal 2 concerned.

### <Frame Image Creation Processing>

A description is made below in detail of the frame image creation processing by the animation processing unit 306 with reference to FIG. 7 to FIG. 9.

FIG. 7 is a flowchart showing an example of operations related to the frame image creation processing in the animation creation processing.

First, as shown in FIG. 7, for example, the region dividing unit 306d of the animation processing unit 306 performs the Delaunay triangulation for the image data of the subject clipped image and the mask image P1, arranges the vertices in the subject regions B at a predetermined interval, and divides the subject regions B into the plurality of image regions Ba . . . (Step S101: refer to FIG. 11B).

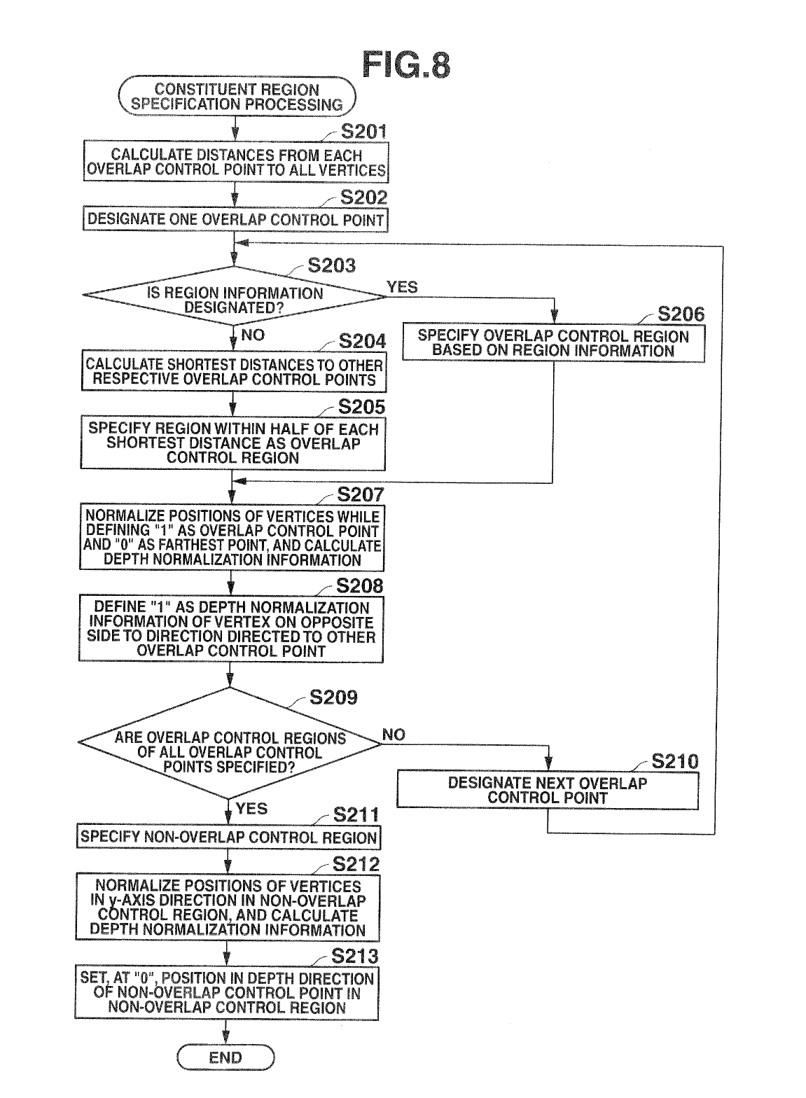

Next, the animation processing unit 306 performs region specification processing (refer to FIG. 8) for the plurality of constituent regions L . . . which compose the subject region B of the mask image P1 (Step S102). Note that the frame image creation processing will be described later.

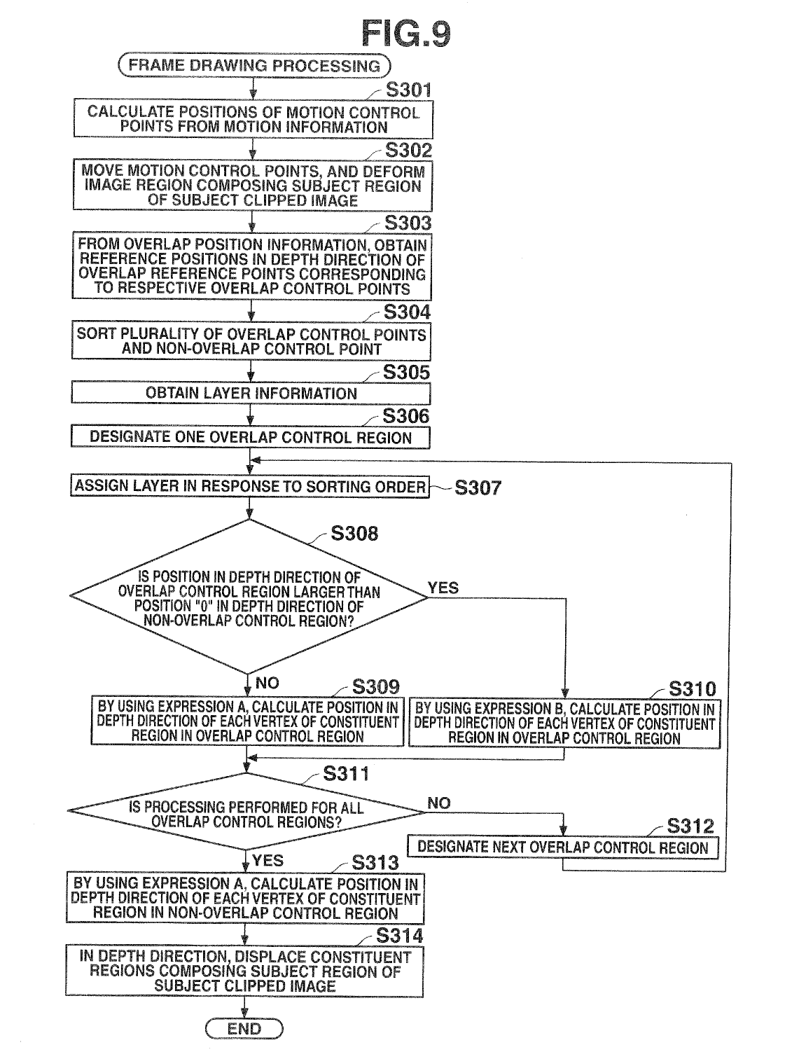

Thereafter, the animation processing unit 306 performs frame drawing processing (refer to FIG. 9) for displacing the plurality of constituent regions L . . . of the subject region B in the depth direction, and in addition, drawing the reference frame images deformed in accordance with the motions of the motion control points S (Step S103). Note that the frame image creation processing will be described later.

Then, the animation processing unit 306 synthesizes the created reference frame images and the background image with each other by using the publicly known image synthesis method (Step S104). Specifically, for example, among the respective pixels of the background image, the animation processing unit 306 allows transmission of the pixels with the alpha value of “0”, and overwrites the pixels with the alpha value of “1” by pixel values of the pixels of the reference frame images, the pixels corresponding thereto. Moreover, among the respective pixels of the background image, with regard to the pixels with the alpha value of “0≦α≦1”, the animation processing unit 306 creates an image (background image×(1−α), in which the subject region of the reference frame image is clipped, by using a complement (1−α) of 1, thereafter, calculates a value obtained by blending the reference frame image with the single background color in the event of creating the reference frame image concerned by using the complement (1−α) of 1 in the alpha map, subtracts the value concerned from the reference frame image, and synthesizes a subtraction resultant with the image (background image×(1−α) from which the subject region is clipped.

In such a way, the frame image creation processing is ended.

### <Constituent Region Specification Processing>

A description is made below in detail of the constituent region specification processing by the animation processing unit 306 with reference to FIG. 8.

FIG. 8 is a flowchart showing an example of operations related to the constituent region specification processing in the frame image creation processing.

First, as shown in FIG. 8, the region specifying unit 306e of the animation processing unit 306 calculates distances from each of the plurality of overlap control points T . . . to the respective vertices of all the image regions Ba obtained by the division of the subject region B by the region dividing unit 306d, for example, by using the Dijkstra's algorithm and the like (Step S201).

Next, the region specifying unit 306e arranges the plurality of overlap control points T in accordance with a predetermined order, and thereafter, designates any one of the overlap control points T (for example, the left wrist overlap control point T1 or the like) (Step S202). Thereafter, the region specifying unit 306e determines whether or not region information for specifying the overlap control region M that takes the designated overlap control point T as a reference is designated (Step S203). Here, as the region information, for example, there is such information as “a region in which the distances from the overlap control point T are within a predetermined number (for example, 100) of pixels is defined as the overlap control region M”. Moreover, with regard to the other overlap control point T nearest the one overlap control point T, as will be described later, in the case where the region, which is composed of the plurality of image regions Ba . . . existing within the distance as a half of the distance between the overlap control points T concerned, is specified as the overlap control region M of the other overlap control point T concerned, then as the region information, there may be defined such information that defines a region, which is composed of the plurality of image regions Ba . . . existing within a remaining half of the distance, as the overlap control region M for the one overlap control point T.

When it is determined in Step S203 that the region information is not designated (Step S203: NO), the region specifying unit 306e calculates a shortest distance to the other overlap control point T (Step S204). Specifically, by using the distances to the respective vertices of all the image regions Ba, which are calculated in Step S201, the region specifying unit 306e calculates shortest distances to the other respective overlap control points T on routes along the edge portions of the plurality of image regions Ba . . . (for example, the triangular image regions Ba) (refer to FIG. 12A).

Then, the region specifying unit 306e specifies the other overlap control point T (for example, the right wrist overlap control point T2), to which the shortest distance is shortest among the calculated shortest distances to the other respective overlap control points T, that is, which exists at the nearest position. Thereafter, the region specifying unit 306e specifies the region, which is composed of the plurality of image regions Ba . . . existing within the distance as a half of the distance to the other overlap control point T concerned, as the overlap control region M of the overlap control point T concerned (Step S205: refer to FIG. 12B).

Meanwhile, in the case where it is determined that the region information is designated in Step S203 (Step S203: YES), the region specifying unit 306e specifies the overlap control region M of the overlap control point T (Step S206) based on the region information concerned (Step S206).

Thereafter, in the specified overlap control region M, the depth position calculating unit 306f of the animation processing unit 306 normalizes the positions of the respective vertices of the plurality of image regions Ba . . . by values within the range of “0” to “1” so that each of the values concerned becomes “1” at the position of the overlap control point T, becomes gradually smaller as the position is being separated from the overlap control point T, and becomes “0” at the position of the vertex existing at the farthest position. In such a way, the depth position calculating unit 306f calculates the depth normalization information (Step S207).

Subsequently, in the specified overlap control region M, in a similar way to the overlap control point T, the depth position calculating unit 306f sets, at “1”, the depth normalization information of each vertex of the predetermined number of image regions Ba existing in the region Ma on the opposite side to the direction directed from the overlap control point T concerned to the other overlap control point T existing at the nearest position (Step S208).

Note that, in the event of performing the normalization by the values within the range of “0” to “1”, the following procedure may be adopted. In the region Ma on the opposite side to the direction directed from the one overlap control point T to the other overlap control point T existing at the nearest position, “1” is set as the depth normalization information of the point farthest from the overlap control point T. “0” is set as mentioned above, and the positions therebetween may be normalized by the values within the range of “0” to “1” in accordance with the distances.

Next, the animation processing unit 306 determines whether or not the overlap control regions M are specified for all the overlap control points T (Step S209).

Here, when it is determined that the overlap control regions M are not specified for all the overlap control points T (Step S209: NO), then among the plurality of overlap control points T . . . , the region specifying unit 306e specifies the overlap control point T (for example, the right wrist overlap control point T2 and the like), which is not designated yet, as the next processing target (Step S210), and thereafter, shifts the processing to Step S203.

Thereafter, the animation processing unit 306 sequentially and repeatedly executes the processing on and after Step S203 until determining that the overlap control regions M are specified for all the overlap control points T in Step S209 (Step S209: YES). In such a way, the overlap control regions M are individually specified for the plurality of overlap control points T . . . .

Then, when it is determined that the overlap control regions M are specified for all the overlap control points T in Step S209 (Step S209: YES), the region specifying unit 306e specifies the non-overlap control regions N in the subject region B of the mask image P1 (Step S211: refer to FIG. 12B). Specifically, the region specifying unit 306e specifies the regions (for example, the respective regions mainly corresponding to the body and the head) of the portions, which remain as a result of that the overlap control regions M are specified in the subject region B of the mask image P1, as the non-overlap control regions N.

Next, for the non-overlap control regions N, the depth position calculating unit 306f normalizes the positions of the respective vertices of the plurality of image regions Ba . . . by the values within the range of “0” to “1” so that the position of the a vertex existing in the uppermost portion (for example, on the head side) can be “1”, and that the position of the vertex existing in the lowermost portion (for example, on the leg side) can be “0”. In such a way, the depth position calculating unit 306f calculates the depth normalization information (Step S212).

Subsequently, the depth position calculating unit 306f defines the arbitrary points of the specified non-overlap control regions N as the non-overlap control points, and sets the position thereof in the depth direction at “0” (Step S213). In such a way, the constituent region specification processing is ended.

### <Frame Drawing Processing>

A description is made below in detail of the frame drawing by the animation processing unit 306 with reference to FIG. 9.

FIG. 9 is a flowchart showing an example of operations related to the frame drawing processing in the frame image creation processing.

As shown in FIG. 9, first, the frame creating unit 306g of the animation processing unit 306 reads out the motion information 305a from the storage unit 305, and based on the motion information 305a concerned, calculates the positions (coordinate information) of the respective motion control points S individually corresponding to the plurality of motion reference points Q . . . in the reference frame image to serve as the processing target (Step S301). Subsequently, the frame creating unit 306g sequentially moves the respective motion control points S to the calculated coordinates, and in addition, moves and deforms the plurality of image regions Ba . . . which compose the subject region B of the subject clipped image (Step S302).

Next, the depth position calculating unit 306f reads out the overlap position information 305b from the storage unit 305, and obtains the reference positions in the depth direction of the overlap reference points R which correspond to the overlap control points T individually related to the plurality of overlap control regions M . . . (Step S303).

Subsequently, based on the reference positions in the depth direction of the overlap reference points R individually corresponding to the plurality of overlap control regions M . . . , and on the positions “0” in the depth direction of the non-overlap control points, the depth position calculating unit 306f sorts the plurality of overlap control points T . . . concerned and the non-overlap control point concerned in accordance with the predetermined rule (Step S304). For example, the depth position calculating unit 306f sorts the left wrist overlap control point T1, the right wrist overlap control point T2, the non-overlap control points, the left ankle overlap control point T3 and the right ankle overlap control point T4 in this order.

Then, the depth position calculating unit 306f obtains layer information related to the predetermined number of layers, which is stored in the predetermined storage unit (for example, the memory and the like) (Step S305: refer to FIG. 10).

Subsequently, among the overlap control regions M related to the plurality of overlap control points T . . . and the non-overlap control regions N related to the non-overlap control points, the depth position calculating unit 306f designates anyone of the overlap control regions M (for example, the overlap control region M located in a deepest side) in accordance with such a sorting order (Step S306). For example, the depth position calculating unit 306f designates the left arm overlap control region M1 related to the left wrist overlap control point T1.

Then, the depth position calculating unit 306f assigns the corresponding layer (for example, the first layer and the like) to the designated overlap control region M (for example, the left arm overlap control region M1) in accordance with the sorting order (Step S307).

Next, the depth position calculating unit 306f determines whether or not the reference position in the depth direction of the overlap reference point R corresponding to the overlap control region M to serve as the processing target is larger than the position “0” in the depth direction of each of the non-overlap control points related to the non-overlap control regions N (Step S308).

Here, when it is determined that the reference position concerned is smaller than the position “0” in the depth direction of the non-overlap control point (Step S308: NO), the depth position calculating unit 306f calculates the position “Zpos” in the depth direction of each vertex of the image region Ba in the layer, the image region Ba composing the overlap control region M (for example, the left arm control region M1 and the like) concerned, based on the following Expression A (Step S309). Specifically, the depth position calculating unit 306f calculates the position “Zpos” in the depth direction of each vertex in the layer so that the position concerned can be on a depth side as the depth normalization information is being closer to “1” and can be on a front side as the depth normalization information is being closer to “0”.

Zpos=“depth normalization information”*“LayerW”+“LayerMin” Expression A

Meanwhile, when it is determined that the reference position is larger than the position “0” in the depth direction of the non-overlap control point in Step S308 (Step S308: YES), the depth position calculating unit 306f calculates the position “Zpos” in the depth direction of each vertex of the image region Ba in the layer, the image region Ba composing the overlap control region M (for example, the left leg overlap control region M3 and the like) concerned, based on the following Expression B (Step S310). That is to say, the depth position calculating unit 306f calculates the position “Zpos” in the depth direction of each vertex in the layer so that the position concerned can be on the front side as the depth normalization information is being closer to “1” and can be on the depth side as the depth normalization information is being closer to “0”.

Zpos=(1−“depth normalization information”)*“LayerW”+“LayerMin” Expression B

Next, the depth position calculating unit 306f determines whether or not such processing for calculating the position “Zpos” in the depth direction of each vertex is performed for all the overlap control regions M (Step S311).

Here, when it is determined that the processing concerned is not performed for all the overlap control regions M (Step S311: NO), then among the plurality of overlap control regions M . . . , the depth position calculating unit 306f designates the overlap control region M (for example, the right arm overlap control region M2 and the like), which is not designated yet, as the next processing target in the sorting order (Step S312). Thereafter, the depth position calculating unit 306f shifts the processing to Step S307.

Thereafter, the depth position calculating unit 306f sequentially and repeatedly executes the processing on and after Step S307 until determining that the processing is performed for all the overlap control regions M in Step S311 (Step S311: YES). In such a way, the positions “Zpos” in the depth direction of the respective vertices are individually calculated for the plurality of overlap control regions M . . . .

Then, when it is determined that the processing is performed for all the overlap control regions M in Step S311 (Step S311: YES), the depth position calculating unit 306f calculates the position “Zpos” in the depth direction of each vertex of the image region Ba in the layer, the image region Ba composing the non-overlap control region N, based on the foregoing Expression A (Step S313). That is to say, the depth position calculating unit 306f calculates the position “Zpos” in the depth direction of each vertex in the layer so that the position concerned can be on the depth side as the depth normalization information is being closer to “1” and can be on the front side as the depth normalization information is being closer to “0”.

Thereafter, for example, by using the three-dimensional drawing interface such as Open GL, the frame creating unit 306g displaces the respective constituent regions L in the subject region of the subject clipped image in the depth direction at the positions different from one another in the depth direction concerned based on the positions “Zpos” in the depth direction of the plurality of constituent regions L . . . (the plurality of overlap control regions M . . . , the non-overlap control regions N and the like), the positions “Zpos” being calculated by the depth position calculating unit 306f (Step S314). As a result, the reference frame image is created, in which the respective constituent regions L in the subject region of the subject clipped image are displaced in the depth direction, and in addition, the subject region is deformed.

In such a way, the frame drawing processing is ended.

As described above, in accordance with the animation creation system 100 of this embodiment, based on the reference position of the overlap reference point R in the depth direction with respect to the two-dimensional space, the overlap reference position R corresponding to each of the plurality of overlap control points T . . . , the server 3 can calculate the position in the depth direction of each of the plurality of constituent regions L . . . for each predetermined time interval. Based on the calculated position in the depth direction of each of the plurality of constituent regions L . . . for each predetermined time interval, the server 3 can displace each of the constituent regions L in the subject region in the depth direction at the positions different from one another in the depth direction concerned for each predetermined time interval. In addition, the server 3 can create the reference frame image (deformed image) obtained by deforming the subject region in accordance with the motions of the plurality of motion control points S . . . set in the subject region. That is to say, in the case of creating the deformed image obtained by deforming the subject region of the two-dimensional still image in accordance with the motions of the plurality of motion control points S, even if the motions are such motions that overlaps a part of the subject region of the still image on the other region thereof fore and aft, then the respective constituent regions L composing the subject region are displaced in the depth direction at the positions different from one another in the depth direction concerned, whereby each of the plurality of constituent regions L . . . does not exist at a position equal to those of other constituent regions L in the depth direction, and the expression of the depth can be made as appropriate in the deformed image obtained by deforming the two-dimensional still image. As a result, the creation of the animation composed of the plurality of frames which express the desired motions of the user can be performed as appropriate.

Moreover, for each of the plurality of overlap control points T . . . , the server 3 specifies the plurality of overlap control regions M among the subject region B while taking, as a reference, the distance to the other overlap control point T existing at the nearest position. Then, the server 3 calculates the position in the depth direction of each of the plurality of overlap control regions M . . . for each predetermined time interval based on the reference position in the depth direction of the overlap reference point R corresponding to each of the plurality of overlap control regions M. Accordingly, in the case of specifying the plurality of overlap control regions M as the constituent regions L, which are displaced in the depth direction at the positions different from one another in the depth direction concerned, in the subject region B, then for one overlap control point T, the distance thereof to the other overlap control point T existing at the nearest position can be taken into consideration, and an overlap control region M with a size of a good balance with respect to the size of the overlap control region M corresponding to the other overlap control point T. In such a way, the expression of such a motion of overlapping one overlap control region M on the other overlap control region M in the deformed image fore and aft can be made as appropriate.

Furthermore, for each of the plurality of overlap control regions M . . . , the server 3 calculates the positions in the depth direction of the vertices of the plurality of image regions Ba . . . , which are obtained by the division of each overlap control region M, while taking the distance thereof from the control point T related to each overlap control region M. Accordingly, the expression of the depth of the plurality of image regions Ba, which compose the overlap control regions M in the deformed image, can be made as appropriate.

Note that the foregoing distance is the distance related to the edge portions of the plurality of image regions Ba . . . obtained by the division of the subject region B, and accordingly, the calculation of the distances among the overlap control points T and the distances from the overlap control points T to the vertices of the respective image regions Ba can be performed as appropriate.

Moreover, the server 3 specifies the non-overlap control regions N, which are other than the plurality of overlap control regions M . . . in the subject region B, as the constituent regions L, and calculates the position in the depth direction of each of the non-overlap control regions N for each predetermined time interval so that the respective pixels composing the non-overlap control region N concerned can be located at the positions different from one another in the depth direction. Accordingly, not only the expression of the depth of the respective pixels composing the non-overlap control regions N in the deformed image can be made, but also the expression of such a motion of overlapping the non-overlap control regions N and the overlap control regions Mon each other in the deformed image fore and aft can be made as appropriate.

In particular, while taking the position in the depth direction of each of the non-overlap control regions N as a reference, the server 3 calculates the positions in the depth direction of the plurality of overlap control regions M . . . , which are the regions relatively on the end portion side of the subject region B concerned, and are adjacent to the non-overlap control region N. Accordingly, the calculation of the positions in the depth direction of the plurality of overlap control regions M can be performed as appropriate, and the expression of such a motion of overlapping the one overlap control region M in the deformed image on the other overlap control region M and the non-overlap control region N fore and aft can be made as appropriate.

Furthermore, in the subject region B of the still image, the server 3 sets the plurality of motion control points S . . . at the positions corresponding to the plurality of motion reference points Q . . . set in the model region A of the moving subject model of the reference image. Accordingly, the setting of the plurality of motion control points S can be performed as appropriate while taking the positions of the plurality of motion reference points Q . . . as references, and deformation of the two-dimensional still image, that is, the creation of the deformed image can be performed as appropriate.

Specifically, based on the motion information 305a indicating the motions of the plurality of motion reference points Q for each predetermined time interval, the motion reference points Q being set in the model region A of the reference image, the plurality of motion control points S . . . are moved based on the motions of the plurality of motion reference points Q . . . for each predetermined time interval, the motion reference points Q being related to the motion information 305a concerned, and the subject region is deformed in accordance with the motions of these plural motion control points S . . . , whereby the deformed image for each predetermined time interval can be created as appropriate.

Note that the present invention is not limited to the foregoing embodiment, and may be improved and changed in design in various ways within the scope without departing from the spirit of the present invention concerned.

For example, in the foregoing embodiment, based on the predetermined operation for the user terminal 2 by the user, the animation is created by the server (image forming apparatus) 3 that functions as a Web server; however, this is merely an example, and the configuration of the image forming apparatus is changeable appropriately and arbitrarily. That is to say, a configuration is adopted, in which the function of the animation processing unit 306 related to the creation of the reference frame image as the deformed image is realized by software, and then the software concerned is installed in the user terminal 2. In such a way, the animation creation processing may be performed only by the user terminal 2 itself without requiring the communication network N.

Moreover, in the foregoing embodiment, the distances between the overlap control points T and the distances from each of the overlap control points T to the vertices of the respective image regions Ba are calculated based on the distances related to the routes along the edge portions of the plurality of image regions Ba . . . obtained by dividing the subject region B; however, such a calculation method of the distances between the overlap control points T and the distances from each of the overlap control points T to the vertices of the respective image regions Ba is merely an example, and the calculation method of the present invention is not limited to this, and is changeable appropriately and arbitrarily.

Moreover, in the foregoing embodiment, the regions other than the plurality of overlap control regions M in the subject regions B of the subject clipped image and the mask image are specified as the non-overlap control regions N; however, whether or not to specify the non-overlap control regions N is changeable appropriately and arbitrarily. That is to say, in the case where such a non-overlap control region N is set on the center side of each subject region B, and the overlap control regions M are set in regions with relatively large motions, such as the arms and the legs, then it is difficult to assume such a motion of actively moving the non-overlap control region N concerned and overlapping the non-overlap control region N on the overlap control region M fore and aft. Accordingly, it is not always necessary to specify the non-overlap control regions N.

Furthermore, in the animation creation processing of the foregoing embodiment, the plurality of motion control points S . . . are set in the subject region of the still image (first setting step), and thereafter, the plurality of overlap control points are T . . . are set in the subject region of the still image (second setting step); however, such an order of setting the motion control points S and the overlap control points T is merely an example, and the setting method of the present invention is not limited to this, and the setting order may be inverted, or the first setting step and the second setting step may be performed simultaneously.

Moreover, the animation creation processing of the foregoing embodiment may be configured so as to be capable of adjusting the synthetic positions and sizes of the subject images. That is to say, in the case of having determined that an adjustment instruction for the synthetic positions and the sizes of the subject images is inputted based on the predetermined operation for the operation input unit 202 by the user, the central control unit 201 of the user terminal 2 transmits a signal, which corresponds to the adjustment instruction concerned, to the server 3 through the predetermined communication network N by the communication control unit 206. Then, based on the adjustment instruction inputted through the communication control unit, the animation processing unit 306 of the server 3 may set the synthetic positions of the subject images at desired synthetic positions, or may set the sizes of the subject at desired sizes.

Furthermore, in the foregoing embodiment, the personal computer is illustrated as the user terminal 2; however, this is merely an example, and the user terminal of the present invention is not limited to this, and is changeable appropriately and arbitrarily. For example, a cellular phone and the like may be applied as the user terminal.

Note that control information for prohibiting a predetermined modification by the user may be embedded in the data of the subject clipped image and the animation.

In addition, in the foregoing embodiment, a configuration is adopted, in which the functions as the obtaining unit, the first setting unit, the second setting unit, the calculating unit and the creating unit are realized in such a manner that the image obtaining unit 306a, the first setting unit 306b, the second setting unit 306c, the depth position calculating unit 306f and the frame creating unit 306g are driven under the control of the central control unit 301. However, the configuration of the present invention is not limited to this, and a configuration that is realized in such a manner that a predetermined program and the like are executed by the CPU of the central control unit 301 may be adopted.

That is to say, in a program memory (not shown) that stores programs, a program is stored in advance, which includes a obtaining processing routine, a first setting processing routine, a second setting processing routine, a calculation processing routine, and a creation processing routine. Then, by the obtaining processing routine, the CPU of the central processing unit 301 may be allowed to function as the obtaining unit that obtains the two-dimensional still image. Moreover, by the first setting processing routine, the CPU of the central control unit 301 may be allowed to function as the first setting unit that sets the plurality of motion control points S, which are related to the motion control of the subject, in the subject region B including the subject of the still image obtained by the obtaining unit. Furthermore, by the second setting processing routine, the CPU of the central control unit 301 may be allowed to function as the second setting unit that sets the plurality of overlap control points T, which are related to the overlap control for the plurality of constituent regions L . . . composing the subject region B, at the respective positions corresponding to the plurality of overlap reference points R . . . in the subject region B of the still image obtained by the obtaining unit. Moreover, by the calculation processing routine, the CPU of the central control unit 301 may be allowed to function as the calculating unit that calculates the position in the depth direction of each of the plurality of constituent regions L . . . for each predetermined time interval based on the reference position in the depth direction of the overlap reference point R corresponding to each of the plurality of overlap control points T . . . . Furthermore, by the creation processing routine, the CPU of the central control unit 301 may be allowed to function as the creating unit that displaces the respective constituent regions L in the subject region in the depth direction for each predetermined time interval at the positions different from one another in the depth direction concerned based on the position in the depth direction of each of the plurality of constituent regions L . . . for each predetermined time interval, the position being calculated by the calculating unit, and in addition, creates the deformed image obtained by deforming the subject region in accordance with the motions of the plurality of motion control points S . . . .

Moreover, as a computer-readable medium that stores therein the program for executing the respective pieces of the foregoing processing, it is also possible to apply a nonvolatile memory such as a flash memory and a portable recording medium such as a CD-ROM as well as the ROM, the hard disc and the like. Moreover, as a medium that provides the data of the program through the predetermined communication network, a carrier wave is also applied.

What is claimed is:

1. An image creation method that uses an image creation apparatus including a storage unit that stores positional information indicating positions of a plurality of overlap reference points in a two-dimensional space, the positions being set for each of a plurality of regions composing a model region including a moving subject model of a reference image, and being associated with a reference position in a depth direction with respect to the two-dimensional space for each predetermined time interval, the image creation method comprising:
obtaining a two-dimensional still image;
first setting a plurality of motion control points related to motion control for a subject in a subject region of the still image obtained by the obtaining, the subject region including the subject;
second setting a plurality of overlap control points related to overlap control for a plurality of constituent regions, the constituent regions composing the subject region, at respective positions corresponding to the plurality of overlap reference points in the subject region of the still image obtained by the obtaining;
calculating a position in the depth direction of each of the plurality of constituent regions for each predetermined time interval based on the reference position in the depth direction of the overlap reference point corresponding to each of the plurality of overlap control points; and
creating a deformed image obtained by deforming the subject region in accordance with motions of the plurality of motion control points,
wherein the creating includes displacing the respective constituent regions in the subject region in the depth direction at positions different from one another in the depth direction for each predetermined time interval based on the position in the depth direction for each predetermined time interval, the position being calculated by the calculating.

2. The image creation method according to claim 1, further comprising:
specifying, for each of the plurality of overlap control points, a plurality of overlap control regions as the constituent regions in the subject region while taking a distance to another overlap control point existing at a nearest position as a reference,
wherein the calculating calculates a position in the depth direction of each of the plurality of constituent regions for each predetermined time interval, the constituent regions being specified by the specifying, based on a reference position in the depth direction of the overlap reference point corresponding to the overlap control point related to each of the overlap control regions.

3. The image creation method according to claim 2,
wherein the specifying further specifies, as the constituent region, a non-overlap control region other than the plurality of overlap control regions in the subject region, and
the calculating calculates a position in the depth direction of the non-overlap control region for each predetermined time interval so that respective pixels composing the non-overlap control region specified by the specifying are located at positions different from one another in the depth direction.

4. The image creation method according to claim 3,
wherein the plurality of overlap control regions are regions on end portion sides of the subject region, the regions being adjacent to the non-overlap control region, and
the calculating calculates the positions in the depth direction of the plurality of overlap control regions while taking the position in the depth direction of the non-overlap control region as a reference.

5. The image creation method according to claim 2,
wherein, for each of the plurality of overlap control regions, the calculating further calculates positions in the depth direction of vertices of a plurality of image regions obtained by dividing each of the overlap control regions while taking, as references, distances thereto from the overlap control point related to each of the overlap control regions.

6. The image creation method according to claim 2,
wherein the distance is a distance related to a route along edge portions of a plurality of image regions obtained by dividing the subject region.

7. The image creation method according to claim 1,
wherein the first setting sets the plurality of motion control points at positions corresponding to the plurality of motion reference points set in the model region of the reference image in the subject region of the still image.

8. The image creation method according to claim 7,
wherein the storage unit further stores motion information indicating motions of the plurality of motion reference points for each predetermined time interval, the motion reference points being set in the model region of the reference image, and
the creating further moves the plurality of motion control points based on motions of the plurality of motion reference points for each predetermined time interval, the motion reference points being related to the motion information stored in the storage unit, and creates the deformed image by deforming the subject region in accordance with motions of the plurality of motion control points.

9. An image creation apparatus including a storage unit that stores positional information indicating positions of a plurality of overlap reference points in a two-dimensional space, the positions being set for each of a plurality of regions composing a model region including a moving subject model of a reference image, and being associated with a reference position in a depth direction with respect to the two-dimensional space for each predetermined time interval, the image creation apparauts comprising:
an obtaining unit which obtains a two-dimensional still image;
a first setting unit which sets a plurality of motion control points related to motion control for a subject in a subject region of the still image obtained by the obtaining unit, the subject region including the subject;
a second setting unit which sets a plurality of overlap control points related to overlap control for a plurality of constituent regions, the constituent regions composing the subject region, at respective positions corresponding to the plurality of overlap reference points in the subject region of the still image obtained by the obtaining unit;
a calculating unit which calculates a position in the depth direction of each of the plurality of constituent regions for each predetermined time interval based on the reference position in the depth direction of the overlap reference point corresponding to each of the plurality of overlap control points; and
a creating unit which creates a deformed image obtained by deforming the subject region in accordance with motions of the plurality of motion control points,
wherein the creating unit performs processing of displacing the respective constituent regions in the subject region in the depth direction at positions different from one another in the depth direction for each predetermined time interval based on the position in the depth direction for each predetermined time interval in the plurality of constituent regions, the position being calculated by the calculating unit.

10. The image creation apparatus according to claim 9, further comprising:
a specifying unit which specifies, for each of the plurality of overlap control points, a plurality of overlap control regions as the constituent regions in the subject region while taking a distance to another overlap control point existing at a nearest position as a reference,
wherein the calculating unit calculates a position in the depth direction of each of the plurality of constituent regions for each predetermined time interval, the constituent regions being specified by the specifying unit, based on a reference position in the depth direction of the overlap reference point corresponding to the overlap control point related to each of the overlap control regions.

11. The image creation apparatus according to claim 10,
wherein the specifying unit further specifies, as the constituent region, a non-overlap control region other than the plurality of overlap control regions in the subject region, and
the calculating unit calculates a position in the depth direction of the non-overlap control region for each predetermined time interval so that respective pixels composing the non-overlap control region specified by the specifying unit are located at positions different from one another in the depth direction.

12. The image creation apparatus according to claim 11,
wherein the plurality of overlap control regions are regions on end portion sides of the subject region, the regions being adjacent to the non-overlap control region, and
the calculating unit calculates the positions in the depth direction of the plurality of overlap control regions while taking the position in the depth direction of the non-overlap control region as a reference.

13. The image creation apparatus according to claim 10,
wherein, for each of the plurality of overlap control regions, the calculating unit further calculates positions in the depth direction of vertices of a plurality of image regions obtained by dividing each of the overlap control regions while taking, as references, distances thereto from the overlap control point related to each of the overlap control regions.

14. The image creation apparatus according to claim 10,
wherein the distance is a distance related to a route along edge portions of a plurality of image regions obtained by dividing the subject region.

15. The image creation apparatus according to claim 9,
wherein the first setting unit sets the plurality of motion control points at positions corresponding to the plurality of motion reference points set in the model region of the reference image in the subject region of the still image.

16. The image creation apparatus according to claim 15,
wherein the storage unit further stores motion information indicating motions of the plurality of motion reference points for each predetermined time interval, the motion reference points being set in the model region of the reference image, and
the creating unit further moves the plurality of motion control points based on motions of the plurality of motion reference points for each predetermined time interval, the motion reference points being related to the motion information stored in the storage unit, and creates the deformed image by deforming the subject region in accordance with motions of the plurality of motion control points.

17. A recording medium recording a program which makes a computer of an image creation apparatus including a storage unit that stores positional information indicating positions of a plurality of overlap reference points in a two-dimensional space, the positions being set for each of a plurality of regions composing a model region including a moving subject model of a reference image, and being associated with a reference position in a depth direction with respect to the two-dimensional space for each predetermined time interval, function as:
an obtaining function which obtains a two-dimensional still image;
a first setting function which sets a plurality of motion control points related to motion control for a subject in a subject region of the still image obtained by the obtaining function, the subject region including the subject;
a second setting function which sets a plurality of overlap control points related to overlap control for a plurality of constituent regions, the constituent regions composing the subject region, at respective positions corresponding to the plurality of overlap reference points in the subject region of the still image obtained by the obtaining function;
a calculating function which calculates a position in the depth direction of each of the plurality of constituent regions for each predetermined time interval based on the reference position in the depth direction of the overlap reference point corresponding to each of the plurality of overlap control points; and
a creating function which creates a deformed image obtained by deforming the subject region in accordance with motions of the plurality of motion control points,
wherein the creating function includes a function of displacing the respective constituent regions in the subject region in the depth direction at positions different from one another in the depth direction for each predetermined time interval based on the position in the depth direction for each predetermined time interval in the plurality of constituent regions, the position being calculated by the calculating function.

18. The recording medium recording the program according to claim 17, the program further comprising:
a specifying function which specifies, for each of the plurality of overlap control points, a plurality of overlap control regions as the constituent regions in the subject region while taking a distance to another overlap control point existing at a nearest position as a reference,
wherein the calculating function calculates a position in the depth direction of each of the plurality of constituent regions for each predetermined time interval, the constituent regions being specified by the specifying function, based on a reference position in the depth direction of the overlap reference point corresponding to the overlap control point related to each of the overlap control regions.

19. The recording medium recording the program according to claim 18,
wherein the specifying function further specifies, as the constituent region, a non-overlap control region other than the plurality of overlap control regions in the subject region, and
the calculating function calculates a position in the depth direction of the non-overlap control region for each predetermined time interval so that respective pixels composing the non-overlap control region specified by the specifying function are located at positions different from one another in the depth direction.

20. The recording medium recording the program according to claim 19,
wherein the plurality of overlap control regions are regions on end portion sides of the subject region, the regions being adjacent to the non-overlap control region, and
the calculating function calculates the positions in the depth direction of the plurality of overlap control regions while taking the position in the depth direction of the non-overlap control region as a reference.

21. The recording medium recording the program according to claim 18,
wherein, for each of the plurality of overlap control regions, the calculating function further calculates positions in the depth direction of vertices of a plurality of image regions obtained by dividing each of the overlap control regions while taking, as references, distances thereto from the overlap control point related to each of the overlap control regions.

22. The recording medium recording the program according to claim 18,
wherein the distance is a distance related to a route along edge portions of a plurality of image regions obtained by dividing the subject region.

23. The recording medium recording the program according to claim 17,
wherein the first setting function sets the plurality of motion control points at positions corresponding to the plurality of motion reference points set in the model region of the reference image in the subject region of the still image.

24. The recording medium recording the program according to claim 23,
wherein the storage unit further stores motion information indicating motions of the plurality of motion reference points for each predetermined time interval, the motion reference points being set in the model region of the reference image, and
the creating function further moves the plurality of motion control points based on motions of the plurality of motion reference points for each predetermined time interval, the motion reference points being related to the motion information stored in the storage unit, and creates the deformed image by deforming the subject region in accordance with motions of the plurality of motion control points.
